(19) United States
(12) Patent Application Publication
(10) Pub. No.: US 2026/0283392 A1
(43) Pub. Date: Sep. 24, 2026

(54) BREWING CUP

(71) Applicant: QINGDAO YINGCHUAN PACKAGING CO., LTD., Qingdao (CN)

(72) Inventors: Zhangcheng SU, Qingdao (CN); Zichuan PENG, Qingdao (CN); Kangjun HUANG, Qingdao (CN)

(73) Assignee: QINGDAO YINGCHUAN PACKAGING CO., LTD., Qingdao (CN)

(21) Appl. No.: 19/577,290

(22) Filed: Mar. 24, 2026

(30) Foreign Application Priority Data
Mar. 24, 2025 (CN) 2025205284200

(51) Int. Cl. A47J 31/00; A47J 31/06; A47J 31/20

(52) U.S. Cl. CPC A47J 31/005; A47J 31/0615; A47J 31/20

(57) ABSTRACT

A brewing cup includes a cup body, a filtration assembly, and a pushing member. The cup body is provided with an accommodating chamber with a first opening and a sealed portion. The filtration assembly includes a filtration member and a paper filter which are movably inserted into the accommodating chamber. The paper filter is configured to be pushed by the filtration member to move from the first opening toward the sealed portion and wrap an end portion of the filtration member facing the sealed portion, and filter a mixture of the brewing powder and the liquid solvent in the accommodating chamber to separate residue from liquid in the mixture. The pushing member is configured to push, under an external force, the filtration member and the paper filter to move toward the sealed portion.

### CROSS-REFERENCE TO RELATED APPLICATION

This application is based on and claims the benefit of priority from Chinese Patent Application No. 2025205284200, filed on 24 Mar. 2025, the entirety of which is incorporated by reference herein.

### TECHNICAL FIELD

The present disclosure relates to the field of brewing devices, and in particular, to a brewing cup.

### BACKGROUND

The AeroPress and French Press are two types of brewing devices in the related art for quickly preparing beverages such as coffee, or tea from coffee powder, or similar brewing materials. An AeroPress includes a cylindrical chamber, a plunger, a filter cap, and a paper filter. To brew coffee using an AeroPress, a paper filter is placed at the bottom of a recessed cavity of the filter cap. The filter cap with the paper filter is then assembled to the bottom of the cylindrical chamber to form a filtration assembly. Then, the filtration assembly is placed upright on the top of a separate cup with the filter cap facing downward. Coffee powder and water are respectively added to the cylindrical chamber and stirred. The plunger is inserted into the cylindrical chamber and pressed downward, causing the liquid in the cylindrical chamber to flow through the paper filter and the filter holes in the filter cap and into the cup located below the filter cap, with the residue remaining on the paper filter. Once the plunger is fully pressed, the coffee brewing is complete. A French press includes a carafe, a top lid, a metal filter, and a plunger. To brew coffee using a French press, coffee powder and hot water are added into the carafe successively. The module composed of the top lid, the metal filter, and the plunger is assembled to the carafe, so that the top lid covers an opening at the top of the carafe. The mixture of the coffee powder and hot water is allowed to stand for several minutes. Then, the plunger is pressed downward to cause the plunger to move downward through a through hole in the top lid and push the metal filter downward, so that the residue in the carafe is pressed downward, and the liquid enters the space above the metal filter through the filter holes in the metal filter. Once the plunger is fully pressed, the coffee brewing is complete. The prepared coffee may be poured into a separate cup for drinking.

However, both the AeroPress and the French Press have the following shortcomings in specific applications.
(1) Shortcomings of AeroPress: (1.1) Because the filter residue in the AeroPress is compressed against the paper filter, the residue is likely to block the filter channels and impede the downward flow of liquid into the cup, requiring the user to apply a greater force to press the plunger downward and degrading the user experience. (1.2) Brewing with an AeroPress requires a separate, sturdy cup that fits the filter cap, so a compatible cup must be prepared each time, which is inconvenient. (1.3) The AeroPress's open bottom prevents it from forming a sealed chamber, so it can only be used as a brewing device and cannot serve as a storage container for drinking water or other liquids. (1.4) Because the cylindrical chamber of the AeroPress for mixing coffee powder and water is open at the top, the user has to use an additional agitator to mix the powder and water before inserting the plunger into the cylindrical chamber, in order to achieve a thorough mixing effect.
(2) Shortcomings of French press: (2.1) After brewing using a French press, the coffee residue tends to cling to the metal filter and the carafe, making cleaning cumbersome. (2.2) Because the French press uses a metal filter as its filter element, the filtration precision is low and the filtration effect is poor, resulting in a powdery texture in the brewed coffee, affecting the taste of the coffee. (2.3) The plunger of the French press has a small ball at the top. The user needs to press this ball by hand in order to push the plunger downward. Due to its small surface area, the ball is not very comfortable to operate, making it inconvenient for the user to use the French press. (2.4) The brewed coffee needs to be poured from the carafe into a separate cup for drinking, which is inconvenient for the user. (2.5) Because the top lid of the French press needs to be provided with a through hole in the middle for the plunger to pass through and move up and down, the French press cannot form a sealed space, and cannot be inverted while filled with liquid. Therefore, the French press cannot be used as a storage container for drinking water or other drinking liquids. (2.6) Because the top lid of the French press only covers the opening at the top of the carafe and is not sealedly connected to the carafe, the user has to use an additional agitator to mix the powder and water before placing the top lid on the carafe, in order to achieve a thorough mixing effect.

### SUMMARY

An objective of the present disclosure is to provide a brewing cup to solve the technical problems that brewing devices in the related art are prone to blocking of filter channels and are difficult to clean.

To achieve the above objective, the present disclosure provides the following technical schemes. A brewing cup is provided, including:
a cup body, provided with an accommodating chamber, where one end of the accommodating chamber is provided with a first opening which is open, another end of the accommodating chamber is provided with a sealed portion which is closed and is spaced apart from and opposite to the first opening, and the first opening is configured to allow a brewing powder and a liquid solvent to pass therethrough to enter the accommodating chamber;
a filtration assembly, comprising a filtration member and a paper filter, where the filtration member and the paper filter are respectively separably connected to the cup body, the filtration member and the paper filter are movably inserted in the accommodating chamber, and the paper filter is configured to be pushed by the filtration member to move from the first opening toward the sealed portion and wrap an end portion of the filtration member facing the sealed portion, and filter a mixture of the brewing powder and the liquid solvent in the accommodating chamber to separate residue from liquid in the mixture; and
a pushing member, configured to push, under an external force, the filtration member and the paper filter to move in a direction from the first opening to the sealed portion, causing the filtration member and the paper filter to push the residue in the mixture in the accommodating chamber toward the sealed portion, and causing the liquid in the mixture to pass through the paper filter into a space between the paper filter and the first opening.

In an implementation, before the pushing member pushes the filtration member and the paper filter to move toward the sealed portion, the paper filter is laid on an edge of the first opening, the filtration member is vertically placed on the paper filter, and a spacing exists between the paper filter and a bottom of the filtration member facing the sealed portion; and
after the pushing member pushes the filtration member and the paper filter to move toward the sealed portion, a portion of the paper filter between the bottom of the filtration member and the sealed portion is partially laminated, presses against, and wraps the bottom of the filtration member.

In an implementation, after the pushing member pushes the filtration member and the paper filter to move toward the sealed portion, a portion of the paper filter between the bottom of the filtration member and the sealed portion is compressed and folded to form a pleated structure composed of a laminated structure including at least two layers.

In an implementation, the pleated structure forms three-dimensional channels at a bottom of the paper filter, with a height ranging from 0.2 mm to 1 mm.

In an implementation, the pushing member is separably connected to the filtration member; or
the pushing member is telescopically connected to the filtration member.

In an implementation, the filtration member includes a cylinder and a filtration head, and the filtration head is assembled to or integrally formed on an end of the cylinder facing the sealed portion;
the paper filter is separably connected to the filtration head, and is configured to wrap the filtration head when the filtration member pushes the paper filter to move toward the sealed portion;
the pushing member is separably connected to the cylinder, and is configured to push, under an external force, the cylinder to drive the filtration head and the paper filter to move in the direction from the first opening to the sealed portion.

In an implementation, the filtration head is separably connected to the cylinder.

In an implementation, the filtration head includes a connecting segment, a sealing segment, and a filtration segment arranged in sequence in an axial direction thereof, the connecting segment is separably connected to the cylinder, and the filtration segment is provided with a plurality of filter holes for the liquid to pass through;
the brewing cup further includes a first sealing ring, and the first sealing ring is sleeved over the sealing segment to seal a fitting gap between the sealing segment and an inner side wall of the accommodating chamber when the filtration assembly is inserted into the accommodating chamber; and
the paper filter is at least configured to wrap the filtration segment or wrap the filtration segment and the first sealing ring.

In an implementation, the paper filter is provided with a first concave cavity, the first concave cavity is provided with a first cavity opening facing the first opening and a cavity bottom wall spaced apart from and opposite to the first cavity opening, and the paper filter wraps the filtration head or wrap the filtration segment and the first sealing ring with the first cavity opening facing the first opening; and
the paper filter and the filtration head satisfy at least one of the following conditions: a minimum inner diameter of the first concave cavity is smaller than an outer diameter of a bottom of the filtration segment facing the sealed portion, or a depth of the first concave cavity is greater than a sum of the height of the filtration segment and a height of the sealing segment.

In an implementation, a maximum inner diameter of the first concave cavity is greater than or equal to a maximum outer diameter of the filtration segment; and/or
a diameter of the first concave cavity gradually decreases in a direction from the first cavity opening to the cavity bottom wall.

In an implementation, the filtration head is further provided with a second concave cavity, and the second concave cavity is recessed relative to the connecting segment and extends from the connecting segment to the sealing segment and the filtration segment;
the filtration segment includes a first filtration bottom wall and a first filtration side wall, and the first filtration side wall extends with a gradually increasing diameter or with a constant diameter from a circumferential edge of the first filtration bottom wall to the sealing segment; and
the plurality of filter holes include a plurality of first filter holes formed in the first filtration bottom wall and in communication with the second concave cavity and/or a plurality of second filter holes formed in the first filtration side wall and in communication with the second concave cavity.

In an implementation, the filtration head is further provided with a second concave cavity and a third concave cavity, the second concave cavity is recessed relative to the connecting segment and extends from the connecting segment to the sealing segment and the filtration segment, and the third concave cavity is recessed at a bottom of the filtration segment;
the filtration segment includes a second filtration bottom wall, a second filtration side wall, and a third filtration side wall, the second filtration side wall forms an outer circumferential wall of the filtration segment, the second filtration bottom wall and the third filtration side wall define the third concave cavity, the third filtration side wall extends from a bottom end of the second filtration side wall toward the second concave cavity to a circumferential edge of the second filtration bottom wall; and
the plurality of filter holes includes a plurality of third filter holes formed in the second filtration bottom wall and in communication with the second concave cavity, a plurality of fourth filter holes formed in the second filtration side wall and in communication with the second concave cavity, and a plurality of fifth filter holes formed in the third filtration side wall and in communication with the second concave cavity.

In an implementation, a height of the filtration segment is smaller than or equal to a height of the connecting segment; and/or
a height of the filtration segment is smaller than or equal to a height of the sealing segment.

In an implementation, a maximum outer diameter of the second filtration side wall is smaller than an outer diameter of an end portion of the sealing segment away from the connecting segment; and/or
the second filtration side wall extends with a gradually increasing diameter or with a constant diameter from a bottom wall of the sealing segment in a direction away from the connecting segment, and the third filtration side wall extends with a gradually increasing diameter or with a constant diameter from the bottom end of the second filtration side wall to the circumferential edge of the second filtration bottom wall.

In an implementation, a distribution area of the plurality of filter holes in the filtration segment is greater than or equal to 20% of a surface area of the filtration segment.

In an implementation, a flange extending outward is provided at an edge of a top of the paper filter, and the flange is configured to overlap an edge of the first opening before the pushing member pushes the filtration member and the paper filter to move toward the sealed portion; and/or
a maximum outer diameter of the paper filter is greater than an inner diameter of the first opening.

In an implementation, the filtration member includes a cylinder and a filtration head, and the filtration head is configured to be assembled to or integrally formed on an end of the cylinder facing the sealed portion;
the paper filter is separably connected to the filtration head, and is configured to wrap the filtration head when the filtration member pushes the paper filter to move toward the sealed portion;
at least two first pressing portions spaced apart in a circumferential direction of the cylinder are formed protruding from an inner side wall of the cylinder;
at least two second pressing portions spaced apart in a circumferential direction of the pushing member are formed on an outer circumferential side of the pushing member; and
when the second pressing portions are respectively opposite to and press against the first pressing portions, the pushing member is configured to push, under an external force, the cylinder to drive the filtration head and the paper filter to move in the direction from the first opening to the sealed portion.

In an implementation, a number of the first pressing portions is an integer multiple of a number of the second pressing portions, and the integer multiple is greater than or equal to one; and/or
between the first pressing portion and an end portion of the cylinder away from the filtration head, a spacing is provided, which is smaller than a distance from the first pressing portion to an end portion of the cylinder adjacent to the filtration head.

In an implementation, the pushing member includes a transverse plate and at least two vertical plates, a bottom surface of the transverse plate is connected to a top end of each of the at least two vertical plates, inner sides of the at least two vertical plates adjacent to a central axis of the transverse plate intersect each other, and outer peripheral sides of the at least two vertical plates away from the central axis of the transverse plate are arranged at intervals in a circumferential direction of the transverse plate; and
each of the at least two vertical plates is provided with the respective second pressing portion protruding from the outer peripheral side thereof away from the central axis of the transverse plate, and each of the second pressing portions is arranged adjacent to a bottom end of the respective vertical plate.

In an implementation, each of the first pressing portions is a first protruding block extending in an arc shape in a circumferential direction of the inner side wall of the cylinder; each of the second pressing portions is a second protruding block extending from an end portion of the respective vertical plate away from the transverse plate and protruding from the outer peripheral side of the respective vertical plate; a circumferential extending length of the second protruding block is greater than a circumferential extending length of the respective first protruding block, and the second protruding block is configured to press against the respective first protruding block, so that the second pressing portion presses against the first pressing portion; and/or
a number of the vertical plates is four, threee, or two.

In an implementation, the pushing member includes a rod, and the rod is provided with the second pressing portions protruding from an outer side wall thereof.

In an implementation, each of the first pressing portions is a protrusion protruding from the inner side wall of the cylinder; each of the second pressing portions is a slot, the slot is provided with a slot opening facing the sealed portion and a first slot wall spaced apart from and opposite to the slot opening, and the protrusion is configured to be engaged in the respective slot and press against the first slot wall, so that the second pressing portion presses against the first pressing portion; and/or
the rod is provided with an inner hole along a central axis thereof.

In an implementation, the cylinder is further provided with an elongated opening extending from an outer side wall of the cylinder to the inner side wall of the cylinder.

In an implementation, the brewing cup further includes a top lid separably connected to the cup body, and when the top lid is connected to the cup body, the top lid closes and seals the first opening and defines a sealed space with the cup body; and
an end portion of the pushing member away from the sealed portion is separably connected to the top lid, or the pushing member is integrally formed with the top lid.

In an implementation, the top lid is provided with a gripping portion for a user to grip and push the pushing member, so as to drive the filtration assembly to move in the direction from the first opening to the sealed portion,
where an outer diameter of the gripping portion is greater than or equal to 50% of an inner diameter of the first opening.

In an implementation, the outer diameter of the gripping portion is greater than or equal to 80% of the inner diameter of the first opening.

In an implementation, the brewing cup further includes a second sealing ring arranged between the top lid and the cup body to seal a fitting gap between the top lid and the cup body when the top lid is connected to and closes the cup body.

In an implementation, the cup body includes a cylindrical body and a bottom lid, one end of the cylindrical body is provided with the first opening, another end of the cylindrical body is provided with a second opening, the bottom lid is separably connected to the end of the cylindrical body provided with the second opening, and when the bottom lid is mounted to the cylindrical body, the bottom lid closes and seals the second opening to form the sealed portion.

According to the brewing cup provided by the present disclosure, the filtration assembly is configured to include a filtration member and a paper filter respectively separably connected to the cup body, and the mixture of the brewing powder and the liquid solvent in the cup body is filtered by the paper filter to separate the residue from the liquid in the mixture. As such, the filtration precision of the brewing cup can be improved by the high filtration precision of the paper filter to reduce the powdery taste of the liquid brewed by the brewing cup, and paper filters with different filtration precision may be used to meet different brewing and extraction requirements of users. In addition, in the present disclosure, the pushing member is used to push the filtration member and the paper filter to move, to push the residue in the mixture in the cup body toward the sealed portion, and cause the liquid in the mixture to pass through the paper filter into the space between the paper filter and the first opening. As such, the residue is separated from the pushing member and the filtration member by the paper filter, thereby effectively reducing the difficulty of cleaning the brewing cup after use. Moreover, because the residue is located below the paper filter, the residue preferentially falls down when being pushed downward in the process of the paper filter being pressed downward. Compared with an AeroPress scheme where the residue is compressed on the paper filter, the present disclosure can significantly alleviate the problem that the residue blocks the filter channels of the paper filter, improve the smoothness of the liquid flowing through the paper filter, and allow a user to press the pushing member downward with a smaller force, thereby improving user experience.

### BRIEF DESCRIPTION OF DRAWINGS

To describe the technical schemes of the embodiments of the present disclosure or the related art more clearly, the following briefly introduces the accompanying drawings required for describing the embodiments or the related art. Apparently, the accompanying drawings in the following description show only some embodiments of the present disclosure.

FIG. 1 is a schematic diagram of a brewing cup according to an embodiment of the present disclosure when a pushing member is in a first mounted state;

FIG. 2 is a schematic diagram of a brewing cup according to an embodiment of the present disclosure when a pushing member is in a second mounted state;

FIG. 3 is a schematic diagram illustrating the principle of a paper filter laid on a cup body and a filtration member vertically placed on the paper filter according to an embodiment of the present disclosure;

FIG. 4 is a schematic exploded view of a brewing cup according to an embodiment of the present disclosure;

FIG. 5 is another schematic exploded view of a brewing cup according to an embodiment of the present disclosure;

FIG. 6 is a schematic diagram showing a deformation process of a paper filter moving in a cup body according to an embodiment of the present disclosure;

FIG. 7 is a schematic structural diagram of a paper filter according to an embodiment of the present disclosure from one viewing angle;

FIG. 8 is a schematic structural diagram of a paper filter according to an embodiment of the present disclosure from another viewing angle;

FIG. 9 is a schematic structural diagram of an implementation of a filtration head according to an embodiment of the present disclosure from one viewing angle;

FIG. 10 is a schematic structural diagram of the filtration head shown in FIG. 9 from another viewing angle;

FIG. 11 is a schematic structural diagram of the filtration head shown in FIG. 9 from still another viewing angle;

FIG. 12 is a schematic structural diagram of another implementation of a filtration head according to an embodiment of the present disclosure from one viewing angle;

FIG. 13 is a schematic structural diagram of the filtration head shown in FIG. 12 from another viewing angle;

FIG. 14 is a schematic cross-sectional view of the filtration head shown in FIG. 12;

FIG. 15 is a schematic exploded view of a cup body according to an embodiment of the present disclosure;

FIG. 16 is a schematic structural diagram of a pushing member including a transverse plate and a vertical plate according to an embodiment of the present disclosure;

FIG. 17 is a schematic exploded view of a pushing member and a top lid shown in FIG. 16 according to an embodiment of the present disclosure;

FIG. 18 is a schematic structural diagram of a cylinder configured to fit to the pushing member shown in FIG. 16 according to an embodiment of the present disclosure;

FIG. 19 is a schematic structural assembled view of a pushing member, which is a rod, and a top lid according to an embodiment of the present disclosure; and

FIG. 20 is a schematic structural diagram of a cylinder configured to fit to the pushing member shown in FIG. 19 according to an embodiment of the present disclosure.

List of reference numerals: 10. brewing cup; 100. cup body; 110. cylindrical body; 120. bottom lid; 101. first opening; 102. sealed portion; 103. accommodating chamber; 200. filtration assembly; 201. filtration member; 210. cylinder; 211. first pressing portion; 2111. first protruding block; 2112. protrusion; 212. clearance space; 213. elongated opening; 214. axial through hole; 220. filtration head; 221. connecting segment; 222. filtration segment; 2221. first filtration bottom wall; 2222. first filtration side wall; 2223. first filter hole; 2224. second filter hole; 2225. second filtration bottom wall; 2226. second filtration side wall; 2227. third filtration side wall; 2228. third filter hole; 2229. fourth filter hole; 2220. fifth filter hole; 223. sealing segment; 224. second concave cavity; 225. third concave cavity; 202. paper filter; 2021. first concave cavity; 2022. first cavity opening; 2023. cavity bottom wall; 2024. cavity side wall; 2025. flange; 2026. pleated structure; 2027. paper body; 300. top lid assembly; 310. top lid; 311. gripping portion; 320. pushing member; 321. transverse plate; 322. vertical plate; 323. second pressing portion; 3231. second protruding block; 3232. slot; 3233. slot opening; 3234. first slot wall; 3235. mounting slot segment; 3236. locking slot segment; 3237. second slot wall; 3238. third slot wall; 3239. fourth slot wall; 324. rod; 3241. inner hole; 400. first sealing ring; 500. second sealing ring.

### DETAILED DESCRIPTION

The following clearly and completely describes the technical schemes in the embodiments of the present disclosure with reference to the accompanying drawings in the embodiments of the present disclosure. Apparently, the described embodiments are merely some embodiments of the present disclosure rather than all of the embodiments. All other embodiments obtained by those having ordinary skills in the art without creative efforts based on the embodiments of the present disclosure shall fall within the protection scope of the present disclosure.

The brewing cup provided in the embodiments of the present disclosure is suitable for use as a brewing device for brewing a brewable product into a drinkable or usable liquid, and is particularly suitable for use as a brewing device for brewing a powdered brewable product (i.e., brewing powder) into a drinkable or usable liquid using a liquid solvent, for example, brewing coffee powder, tea powder, or Chinese medicine powder into a drinkable liquid using water or other liquid solvents, or brewing flavor powder using water or other liquid solvents to form a usable flavoring liquid.

The brewing cup provided in the embodiments of the present disclosure is a manually-operated brewing device that can prepare beverages such as coffee and tea or other liquids by manually pressing the brewing cup.

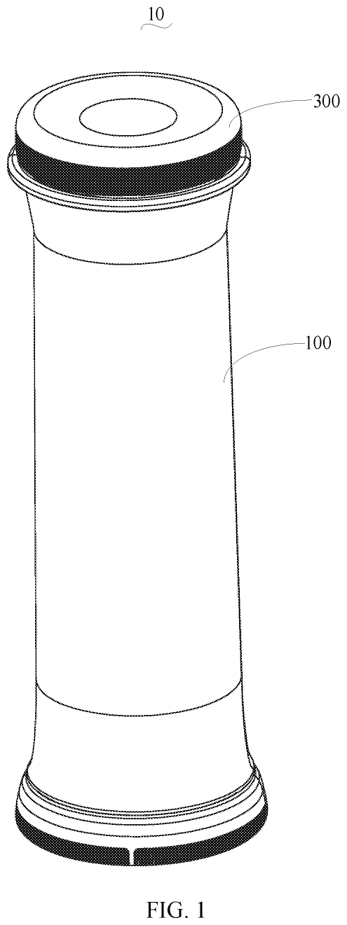

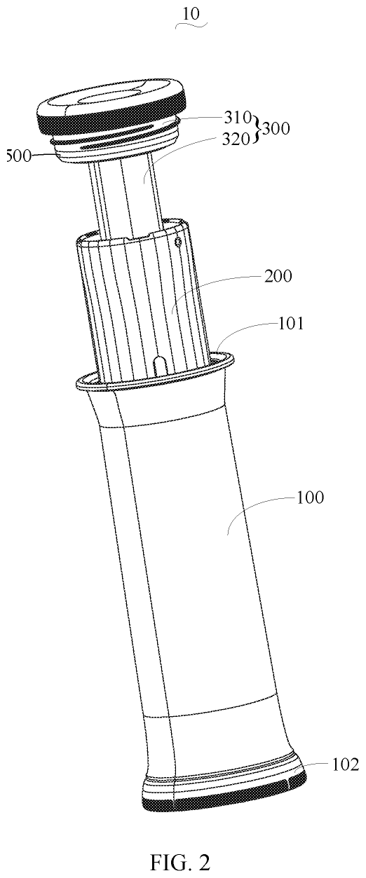

Referring to FIG. 1 and FIG. 2, an embodiment of the present disclosure provides a brewing cup 10, which includes a cup body 100, a filtration assembly 200, and a pushing member 320. The cup body 100 is configured to accommodate a brewing powder and a liquid solvent. The filtration assembly 200 is separably and movably connected to the cup body 100, i.e., the filtration assembly 200 is separably connected to the cup body 100 and can move relative to the cup body 100 under an external force after being connected to the cup body 100. The filtration assembly 200 being separably connected to the cup body 100 means that the filtration assembly 200 is detachably connected to the cup body 100. In other words, the filtration assembly 200 may be assembled to the cup body 100 to achieve connection with the cup body 100, and may be detached from the cup body 100 to achieve separation from the cup body 100. The filtration assembly 200 is configured to filter a mixture of the brewing powder and the liquid solvent in the cup body 100 to separate residue from liquid in the mixture. The pushing member 320 is separably connected to the filtration assembly 200. In other words, the pushing member 320 may be assembled to the filtration assembly 200 to achieve connection with the filtration assembly 200, and may be detached from the filtration assembly 200 to achieve separation from the filtration assembly 200. The pushing member 320 is configured to push the filtration assembly 200 to move in the cup body 100 under an external force, so that the filtration assembly 200 filters the mixture in the cup body 100 to separate the residue from the liquid in the mixture. The process of using the liquid solvent to brew the brewing powder is a process of extracting a target ingredient from the brewing powder with the liquid solvent. In a specific application, when needing to brew the brewing powder with the brewing cup 10, a user may first detach and remove the filtration assembly 200 and the pushing member 320 from the cup body 100, respectively add the brewing powder and the liquid solvent into the cup body 100, and after the brewing powder and the liquid solvent are fully mixed, places the filtration assembly 200 on a top end of the cup body 100. Then, the user may attach the pushing member 320 to the filtration assembly 200, and then press the pushing member 320 downward, so that the filtration assembly 200 can be driven by the pushing member 320 to move into the cup body 100, causing the filtration assembly 200 to push the residue in the mixture in the cup body 100 toward a bottom of the cup body 100. After the filtration assembly 200 is moved into place, the user may detach and remove the pushing member 320. In this case, since the filtration assembly 200 is still located in the cup body 100 to maintain the separation of the liquid from the residue, the user may directly use the cup body 100 to drink the brewed liquid. As such, the brewing cup 10 can be used as both a brewing device and a drinking container, which obviates the need for an additional container, making it more convenient for the user to brew the brewing powder and drink the brewed liquid. Further, since the filtration assembly 200 is detachably connected to the cup body 100, the filtration assembly 200 can be assembled to the cup body 100 to filter the mixture in the cup body 100, and the filtration assembly 200 can be detached and removed from the cup body 100 to meet different usage requirements of users.

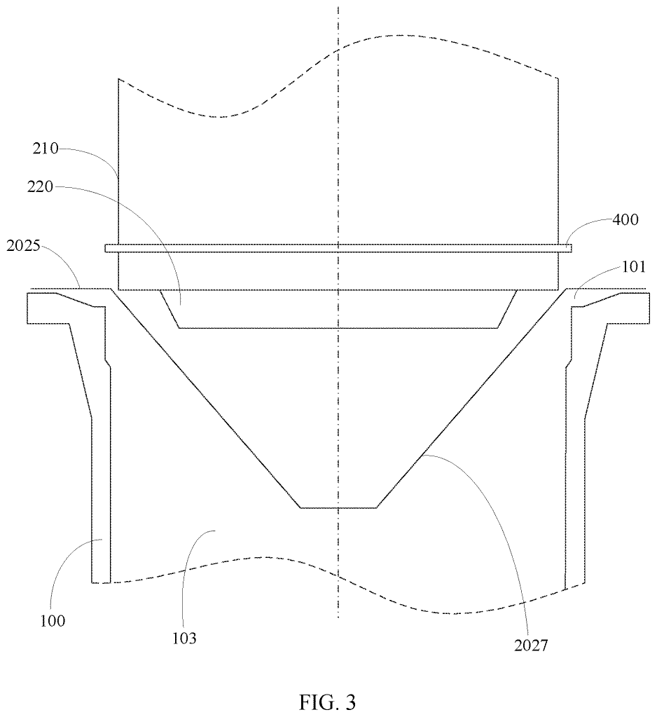

Referring to FIG. 2 and FIG. 3, in an implementation, the cup body 100 is provided with an accommodating chamber 103, one end of the accommodating chamber 103 is provided with a first opening 101 which is open, another end of the accommodating chamber 103 is provided with a sealed portion 102 which is closed and is spaced apart from and opposite to the first opening 101, and the first opening 101 is configured to allow the brewing powder and the liquid solvent to pass therethrough to enter the accommodating chamber 103. The accommodating chamber 103 is a hollow space inside the cup body 100, and may be configured to accommodate a certain volume of the brewing powder and the liquid solvent. The first opening 101 and the sealed portion 102 are respectively located at opposing ends of the cup body 100. For example, the first opening 101 is formed at the top end of the cup body 100, and the sealed portion 102 is formed at a bottom end of the cup body 100. The sealed portion 102 is configured to carry the brewing powder and the liquid solvent placed in the accommodating chamber 103. The filtration assembly 200 and the pushing member 320 may be inserted into the accommodating chamber 103 through the first opening 101. Under an external force, the pushing member 320 may push the filtration assembly 200 to move in a direction from the first opening 101 to the sealed portion 102, causing the filtration assembly 200 to push the residue in the mixture in the accommodating chamber 103 toward the sealed portion 102, and causing the liquid in the mixture to pass through the filtration assembly 200 into a space between the filtration assembly 200 and the first opening 101.

Referring to FIG. 3 to FIG. 5, in an implementation, the filtration assembly 200 includes a filtration member 201 and a paper filter 202. The filtration member 201 and the paper filter 202 are respectively separably connected to the cup body 100. In other words, both the filtration member 201 and the paper filter 202 may be mounted to the cup body 100, and may be detached from the cup body 100 to achieve separation from the cup body 100. Both the filtration member 201 and the paper filter 202 are movably inserted into the accommodating chamber 103, i.e., the filtration member 201 and the paper filter 202 can move in the accommodating chamber 103 under an external force after being mounted to the cup body 100. The paper filter 202 is separably connected to the filtration member 201, i.e., the paper filter 202 may be connected to the filtration member 201, and may be detached from the filtration member 201 to achieve separation from the filtration member 201. The paper filter 202 is configured to be pushed by the filtration member 201 to move from the first opening 102 toward the sealed portion 102 and wrap an end portion of the filtration member 201 facing the sealed portion 102, and filter the mixture of the brewing powder and the liquid solvent in the accommodating chamber 103 to separate the residue from the liquid in the mixture, i.e., the paper filter 202 is configured to wrap a bottom of the filtration member 201 and filter the mixture in the accommodating chamber 103. In this implementation, the paper filter 202 is used to filter the mixture to separate the residue from the liquid, which can greatly improve the filtration precision compared with a metal mesh filter to reduce the powdery texture of the liquid prepared by the brewing cup 10. In addition, paper filters 202 with different filtration precision may be used to meet different brewing and extraction requirements of users. When coffee is brewed using the brewing cup 10, the paper filter 202 can filter the coffee residue more efficiently than a metal mesh filter, which not only significantly improves the taste of the coffee, but also reduces the powder texture of the brewed coffee as much as possible.

In an implementation, the pushing member 320 is separably connected to the filtration member 201, i.e., the pushing member 320 may be connected to the filtration member 201, and may be detached from the filtration member 201 to achieve separation from the filtration member 201. In addition, the pushing member 320 is configured to push, under an external force, the filtration member 201 and the paper filter 202 to move in the direction from the first opening 101 to the sealed portion 102, causing the filtration member 201 and the paper filter 202 to push the residue in the mixture in the accommodating chamber 103 toward the sealed portion 102, and causing the liquid in the mixture to pass through the paper filter 202 into a space between the paper filter 202 and the first opening 101. In a specific application, when needing to brew the brewing powder with the brewing cup 10, a user may add the brewing powder and the liquid solvent into the cup body 100, and after the brewing powder and the liquid solvent are fully mixed, lay the paper filter 202 on a top of the cup body 100, and then vertically place the filtration member 201 on the paper filter 202. Then, the user may attach the pushing member 320 to the filtration assembly 200, and then press the pushing member 320 downward to drive the filtration member 201 and the paper filter 202 to move into the cup body 100, causing the paper filter 202 to push the residue in the mixture in the cup body 100 toward the bottom of the cup body 100. In this implementation, the pushing member 320 is used to push the filtration member 201 and the paper filter 202 to move, to push the residue in the mixture in the cup body 100 toward the sealed portion 102, and cause the liquid in the mixture to pass through the paper filter 202 into the space between the paper filter 202 and the first opening 101. As such, the residue is separated from the pushing member 320 and the filtration member 201 by the paper filter 202, thereby effectively reducing the difficulty of cleaning the brewing cup 10 after use. Of course, in specific applications, the configuration of the pushing member 320 and the filtration member 201 is not limited thereto. For example, in an alternative implementation, the pushing member 320 and the filtration member 201 may be telescopically connected or otherwise movably connected, and the pushing member 320 may be extended or retracted to different states, to allow the pushing member 320 to be received and pushed downward.

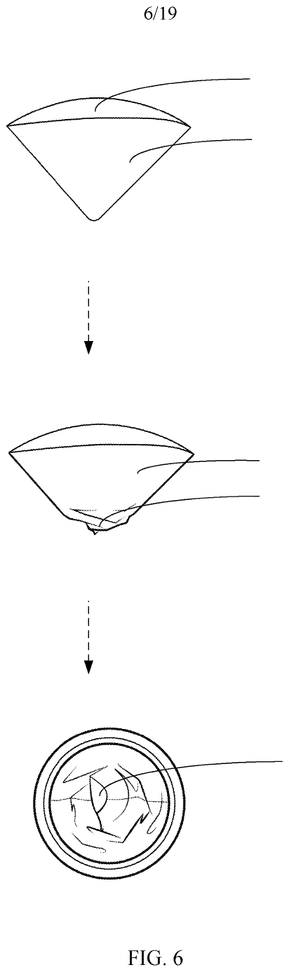

Referring to FIG. 3 to FIG. 6, in an implementation, before the pushing member 320 pushes the filtration member 201 and the paper filter 202 to move toward the sealed portion 102, the paper filter 202 is laid on an edge of the first opening 101, the filtration member 201 is vertically placed on the paper filter 202, and a spacing exists between the paper filter 202 and a bottom of the filtration member 201 facing the sealed portion 102. In other words, after the paper filter 202 is laid on the cup body 100 and the filtration member 201 is vertically placed on the paper filter 202, and before the pushing member 320 is pressed to move downward, the bottom of the filtration member 201 and the paper filter 202 are not in direct contact with each other, but are separated by a spacing, so that there is a space for compression and folding between the paper filter 202 and the bottom of the filtration member 201. As such, in the process of the pushing member 320 pushing the filtration member 201 and the paper filter 202 to move toward the sealed portion 102, the paper filter 202 is gradually compressed, folded, and thus deformed, so that a portion of the paper filter 202 is folded over another portion of the paper filter 202, until the paper filter 202 is compressed and folded to wrap and contact with the bottom of the filtration member 201. After the pushing member 320 pushes the filtration member 201 and the paper filter 202 to move toward the sealed portion 102, a portion of the paper filter 202 between the bottom of the filtration member 201 and the sealed portion 102 is partially laminated, presses against, and wraps the bottom of the filtration member 201, i.e., after the paper filter 202 is compressed and folded, a portion of the paper filter 202 is formed with a laminated structure including at least two layers. The laminated structure including at least two layers that is formed by compression and folding of the paper filter 202 constitutes a pleated structure 2026 (as shown in FIG. 6). The pleated structure 2026 is an irregular folding structure formed by compression and folding of the paper filter 202 while being pressed downward, and three-dimensional channels can be formed by the pleated structure 2026, so that not only the effective filtration area of the paper filter 202 is increased, but also a multi-stage filtration mechanism is provided to achieve the following graded filtration effect. Large residue particles are trapped by gaps of the pleated structure 2026, and fine residue particles are filtered through micropores in the paper filter 202. Such a configuration can further improve the filtration precision and the filtration efficiency, and allows a user to press the pushing member 320 downward with a smaller force. The uneven structure of the pleated structure 2026 can force the liquid to be deflected in multiple directions when flowing through the paper filter 202, which overcomes the limitations of the laminar flow mode of vertical downward infiltration in conventional paper filters, enhances the contact efficiency of the liquid with the surface of the paper filter 202, and reduces the static buildup of residue on the surface of the paper filter 202. In addition, microscopic observation shows that after the brewing is completed using the brewing cup 10 of this implementation, the residue is mainly distributed in the gaps at the edge of the pleated structure 2026, and the micropores in the paper filter 202 remain unobstructed. This is mainly because that the gaps at the edge of the pleated structure 2026 may form a local low pressure region that may induce residue particles to be preferentially adsorbed on a leeward side of the pleated structure 2026 (i.e., the gaps at the edge), rather than directly blocking the micropores in the paper filter 202, and the three-dimensional channels formed by the pleated structure 2026 allow the flowing liquid to scour the adsorbed residue, thereby preventing excessive accumulation of residue particles. In this implementation, by configuring the paper filter 202 into a structure that can be compressed and folded to form the pleated structure 2026 while being pressed downward, irregular three-dimensional channels can be formed by the pleated structure 2026, which optimizes the hydrodynamic behavior of the liquid and the distribution pattern of residue particles, significantly reduces the blocking of the micropores in the paper filter 202, and improving the uniformity and efficiency of extraction of the brewing powder. Such a design overcomes the limitations of the two-dimensional filtration mode of conventional paper filters and provides a completely new scheme for improving the performance of the paper filter 202.

In an implementation, the pleated structure 2026 formed by partial lamination of the portion of the paper filter 202 between the bottom of the filtration member 201 and the sealed portion 102 may form three-dimensional channels having a height of 0.2 mm to 1 mm in the bottom of the paper filter 202, and the three-dimensional channels are irregular. The formation of the three-dimensional channels significantly optimizes the hydrodynamic behavior of the liquid and the distribution pattern of residue particles during filtration, which is conducive to better solving the problem of micropore blocking of conventional paper filters.

In an implementation, the paper filter 202 is disposable. After completing one brewing operation, the paper filter 202 is discarded. A new paper filter 202 is used for the next brewing process.

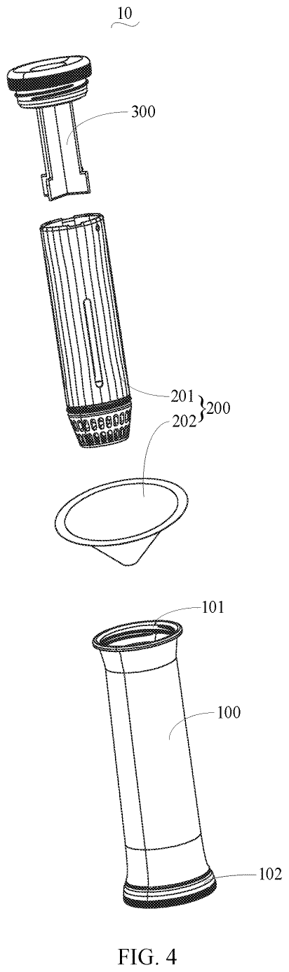

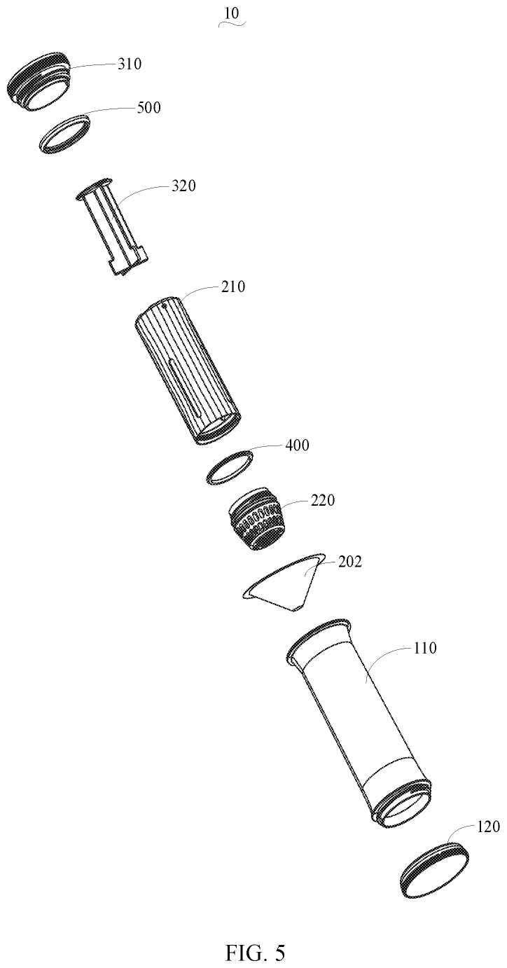

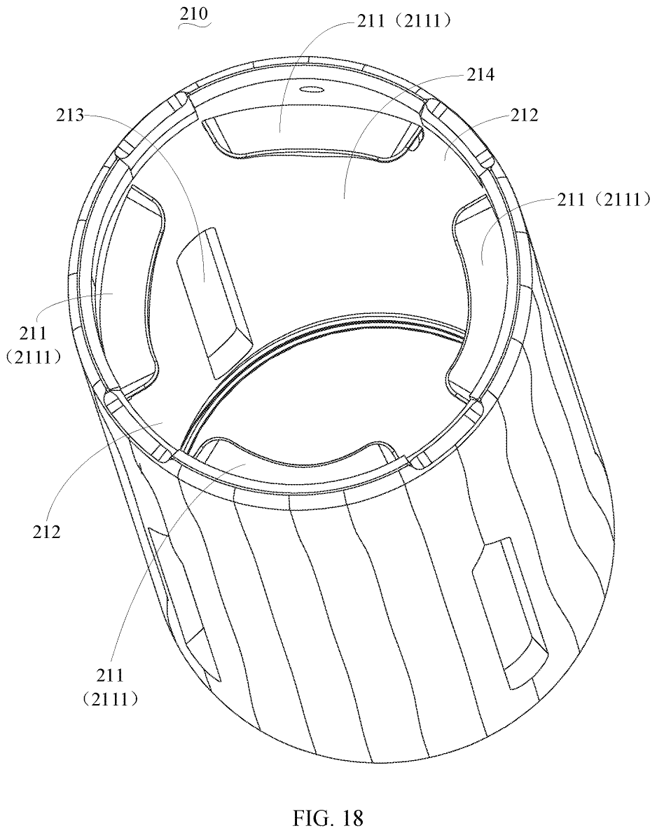

Referring to FIG. 4, FIG. 5, and FIG. 18, in an implementation, the filtration member 201 includes a cylinder 210 and a filtration head 220. The filtration head 220 is assembled to or integrally formed on an end of the cylinder 210 facing the sealed portion 102. In other words, the filtration head 220 is arranged at a bottom end of the cylinder 210, and the filtration head 220 and the cylinder 210 may be two separately formed parts that can be assembled and connected, or may be one integrally formed part. The paper filter 202 is separably connected to the filtration head 220, and when the filtration member 201 pushes the paper filter 202 to move toward the sealed portion 102, the paper filter 202 wraps the filtration head 220. The pushing member 320 is separably connected to the cylinder 210, and is configured to push, under an external force, the cylinder 210 to drive the filtration head 220 and the paper filter 202 to move in the direction from the first opening 101 to the sealed portion 102. The filtration head 220 is fitted to the paper filter 202 to form a filtration part of the filtration assembly 200. The filtration assembly 200 is detachably and movably inserted into the accommodating chamber 103 through the first opening 101 with the filtration part facing the sealed portion 102. The cylinder 210 is an axially hollow member, i.e., an axial through hole 214 is formed through the cylinder 210 in an axial direction of the cylinder 210. The cup body 100 forms an outer cup structure, and the cylinder 210 forms an inner cup structure. The configuration of the cylinder 210 as the top of the filtration assembly 200 is conducive to achieving a nested fit with the pushing member 320, facilitates assembly to the filtration head 220, and can reduce the weight and material cost of the filtration assembly 200. In this implementation, the filtration head 220 is fitted to the paper filter 202 to form the filtration part. This allows to increase the filtration area by the filtration head 220, thereby reducing the resistance experienced by the filtration assembly 200 when pushed to move toward the sealed portion 102, and allowing the user to push the top lid assembly 300 to move toward the sealed portion 102 with a smaller force during the brewing process. As such, this makes it easier for the user to push a top lid assembly 300 to move toward the sealed portion 102 during the brewing process, and improves the overall ease of use of the brewing cup 10.

In an implementation, the filtration head 220 is separably connected to the cylinder 210, i.e., the filtration head 220 may be connected to the bottom end of the cylinder 210, or may be detached from the bottom end of the cylinder 210 to achieve separation from the cylinder 210. In this implementation, the filtration head 220 and the cylinder 210 are two separately formed parts, and the filtration head 220 is detachably connected to the cylinder 210, to facilitate later disassembly, cleaning, maintenance, and replacement of the filtration head 220. Of course, in specific applications, in an alternative implementation, the filtration head 220 and the cylinder 210 may also be one integrally formed part. In another alternative embodiment, the filtration head 220 and the cylinder 210 may be two separately formed parts and are connected in a non-detachable manner, i.e., after the two parts are assembled together, the two parts cannot be separated from each other without breaking the parts.

In an implementation, the cylinder 210 and the filtration head 220 are both rigid members, the paper filter 202 is a flexible member. When the pushing member 320 pushes the cylinder 210 to drive the filtration head 220 and the paper filter 202 to move downward, the cylinder 210 and the filtration head 220 will not be deformed, and the paper filter 202 will be compressed, folded, and thus deformed.

Referring to FIG. 4 and FIG. 5, in an implementation, the brewing cup 10 further includes a first sealing ring 400, and the first sealing ring 400 is sleeved over the filtration head 220 to seal a fitting gap between the filtration head 220 and an inner side wall of the accommodating chamber 103 when the filtration assembly 200 is inserted into the accommodating chamber 103, i.e., the first sealing ring 400 is sealedly fitted to the inner side wall of the accommodating chamber 103. When the filtration assembly 200 is inserted into the cup body 100, the first sealing ring 400 can seal the fitting gap between an outer side wall of the filtration assembly 200 and the inner side wall of the cup body 100, to prevent the residue and liquid from entering the fitting gap between the outer side wall of the filtration assembly 200 and the inner side wall of the cup body 100 from below, thereby further reducing the difficulty of cleaning the brewing cup 10 after use.

Referring to FIG. 3 to FIG. 8, in an implementation, the paper filter 202 is provided with a first concave cavity 2021, the first concave cavity 2021 is provided with a first cavity opening 2022 facing the first opening 101 and a cavity bottom wall 2023 spaced apart from and opposite to the first cavity opening 2022, and the paper filter 202 wraps the filtration head 220 with the first cavity opening 2022 facing the first opening 101. The first concave cavity 2021 is further provided with a cavity side wall 2024, and the cavity side wall 2024 extends from a circumferential edge of the cavity bottom wall 2023 to a circumferential edge of the first cavity opening 2022. The cavity bottom wall 2023 is a bottommost wall surface inside the first concave cavity 2021. The filtration member 201 including the cylinder 210 and the filtration head 220 may be vertically placed on the paper filter 202 through the first cavity opening 2022 of the paper filter 202. Before the pushing member 320 pushes the filtration member 201 and the paper filter 202 to move toward the sealed portion 102, there is a spacing between the bottom of the filtration head 220 and the cavity bottom wall 2023 of the paper filter 202. In other words, before the pushing member 320 is pressed to move downward, the bottom of the filtration member 201 is not in direct contact with the cavity bottom wall 2023 of the paper filter 202, but there is a certain space for compression and folding between the bottom of the filtration member 201 and the cavity bottom wall 2023 of the paper filter 202. In this implementation, the arrangement of the first concave cavity 2021 on the paper filter 202 allows the paper filter 202 to quickly wrap the filtration head 220 through the first concave cavity 2021.

Referring to FIG. 3 to FIG. 10, in an implementation, the filtration head 220 includes a connecting segment 221, a sealing segment 223, and a filtration segment 222 arranged in sequence in an axial direction thereof, i.e., the connecting segment 221, the sealing segment 223, and the filtration segment 222 are arranged in sequence in the vertical direction. The connecting segment 221 is separably connected to the cylinder 210. The filtration segment 222 is provided with a plurality of filter holes for the liquid to pass through. The first sealing ring 400 is sleeved over the sealing segment 223 to seal a fitting gap between the sealing segment 223 and the inner side wall of the accommodating chamber 103 when the filtration assembly 200 is inserted into the accommodating chamber 103. The paper filter 202 is at least configured to separably wrap the filtration segment 222 or wrap the filtration segment 222 and the first sealing ring 400, i.e., the paper filter 202 wraps at least the filtration segment 222 and the first sealing ring 400 with the first cavity opening 2022 facing the first opening 101. In this implementation, the configuration of the paper filter 202 to wrap the filtration segment 222 and the first sealing ring 400 can ensure a filtration function of the paper filter 202 for the mixture, and prevent the residue from contaminating the first sealing ring 400, thereby further reducing the difficulty of cleaning the brewing cup 10 after use. Of course, in specific applications, in an alternative implementation, the paper filter 202 may be configured to wrap the filtration segment 222 only, not wrap the first sealing ring 400.

Referring to FIG. 3 to FIG. 10, in an implementation, the paper filter 202 and the filtration head 220 satisfy at least one of the following conditions: a minimum inner diameter d1 of the first concave cavity 2021 is smaller than an outer diameter d3 of a bottom of the filtration segment 222 facing the sealed portion 102, or a depth h1 of the first concave cavity 2021 is greater than a height h2 of the filtration segment 222. The depth h1 of the first concave cavity 2021 is a distance between the first cavity opening 2022 and the cavity bottom wall 2023. The height h2 of the filtration segment 222 is a distance between a top end and a bottom end of the filtration segment 222, i.e., a dimension of the filtration segment 222 in the vertical direction. Through the configuration of the minimum inner diameter d1 of the first concave cavity 2021 to be smaller than the outer diameter d3 of the bottom of the filtration segment 222, the bottom of the filtration segment 222 cannot enter this part of the first concave cavity 2021, and therefore the filtration head 220 cannot completely enter the paper filter 202. In other words, when the filtration head 220 just enters the first concave cavity 2021, the filtration head 220 cannot enter into direct contact with the cavity bottom wall 2023, and there is a spacing between the bottom of the filtration head 220 and the cavity bottom wall 2023. Through the configuration of the depth h1 of the first concave cavity 2021 to be greater than the height h2 of the filtration segment 222, the filtration head 220 also cannot completely enter the paper filter 202, and there is a spacing between the bottom of the filtration head 220 and the cavity bottom wall 2023. It can be seen that either configuring the minimum inner diameter d1 of the first concave cavity 2021 to be smaller than the outer diameter d3 of the bottom of the filtration segment 222 facing the sealed portion 102 or configuring the depth h1 of the first concave cavity 2021 to be greater than the height h2 of the filtration segment 222 can provide a space for compression and folding between the paper filter 202 and the bottom of the filtration head 220. In this way, the bottom of the paper filter 202 can be compressed and folded to form a pleated shape during t the pushing member 320 pushes the filtration assembly 200 to move toward the sealed portion 102, thereby allowing a user to push the pushing member 320 with a smaller force to cause the filtration assembly 200 to move toward the sealed portion 102.

Referring to FIG. 6 to FIG. 10, in an implementation, the minimum inner diameter d1 of the first concave cavity 2021 is smaller than the outer diameter d3 of the bottom of the filtration segment 222 facing the sealed portion 102, and the depth h1 of the first concave cavity 2021 is greater than the height h2 of the filtration segment 222. In this way, the pleated structure 2026 is formed more easily when the paper filter 202 is pushed downward. The minimum inner diameter d1 of the first concave cavity 2021 is an inner diameter of the cavity bottom wall 2023. In other words, the inner diameter of the cavity bottom wall 2023 is smaller than the outer diameter d3 of the bottom of the filtration segment 222.

Referring to FIG. 6 to FIG. 10, in an implementation, the depth h1 of the first concave cavity 2021 is greater than a sum of the height h2 of the filtration segment 222 and a height h3 of the sealing segment 223. In this way, there is a space for compression and folding between the paper filter 202 and the bottom of the filtration member 201, and it can be ensured that the paper filter 202 wraps both the filtration segment 222 and the first sealing ring 400.

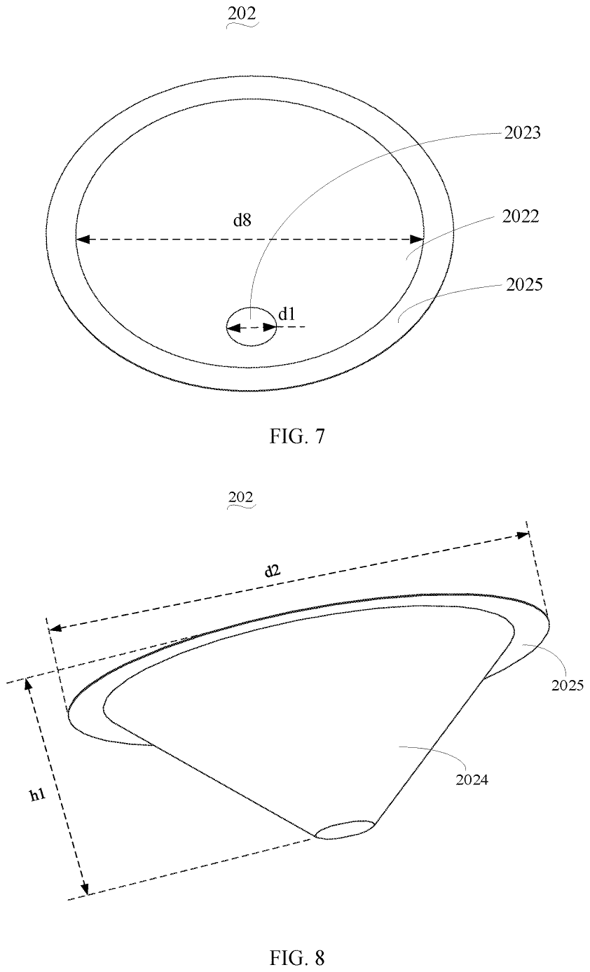

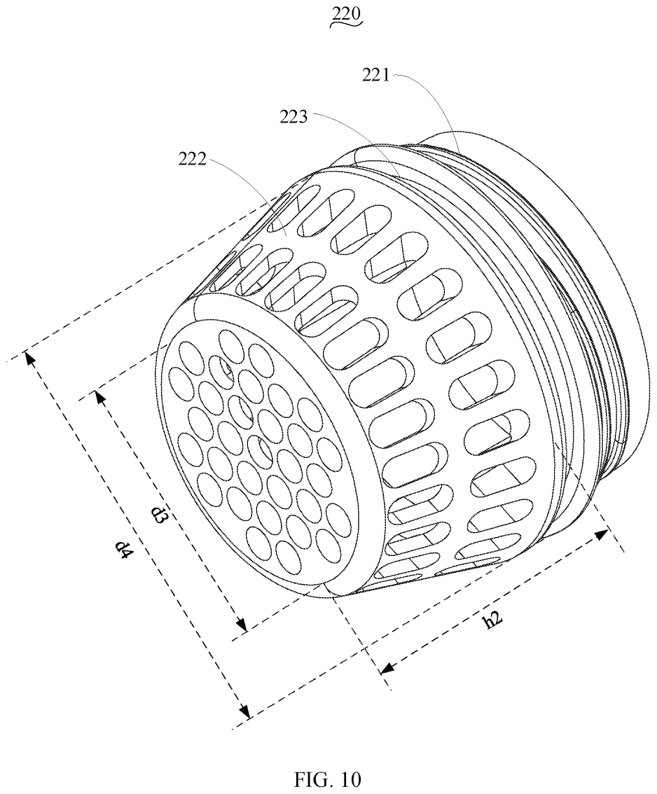

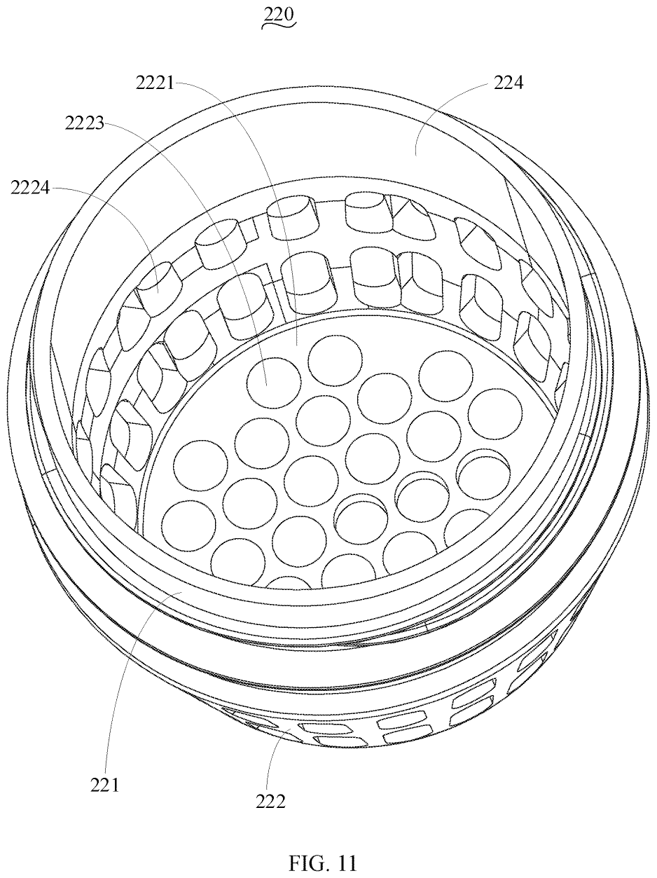

Referring to FIG. 6, FIG. 7, and FIG. 10, in an implementation, a maximum inner diameter d8 of the first concave cavity 2021 is greater than or equal to a maximum outer diameter d4 of the filtration segment 222, to ensure that the paper filter 202 can completely wrap the filtration segment 222.

In an implementation, a diameter of the first concave cavity 2021 gradually decreases in a direction from the first cavity opening 2022 to the cavity bottom wall 2023. In other words, the first concave cavity 2021 is of a conical shape, and an inner diameter of the first concave cavity 2021 gradually decreases from top to bottom, i.e., a top of the first concave cavity 2021 is the part with the largest inner diameter of the first concave cavity 2021, the inner diameter of the top of the first concave cavity 2021 is greater than or equal to the maximum outer diameter of the filtration segment 222, and a bottom of the first concave cavity 2021 is the part with the smallest inner diameter of the first concave cavity 2021. Such a configuration allows the filtration segment 222 to enter the paper filter 202 more easily.

Referring to FIG. 5, FIG. 10, and FIG. 11, in an implementation, the filtration head 220 is further provided with a second concave cavity 224, and the second concave cavity 224 is recessed relative to the connecting segment 221 and extends from the connecting segment 221 to the sealing segment 223 and the filtration segment 222. Specifically, the second concave cavity 224 is recessed downward from a top of the filtration head 220. The plurality of filter holes formed in the filtration segment 222 are respectively in communication with the second concave cavity 224. Through the configuration of the second concave cavity 224, the liquid can flow into the cylinder 210 through the paper filter 202, the filter holes, and the second concave cavity 224 in sequence during the pushing member 320 pushes the filtration assembly 200 to move toward the sealed portion 102.

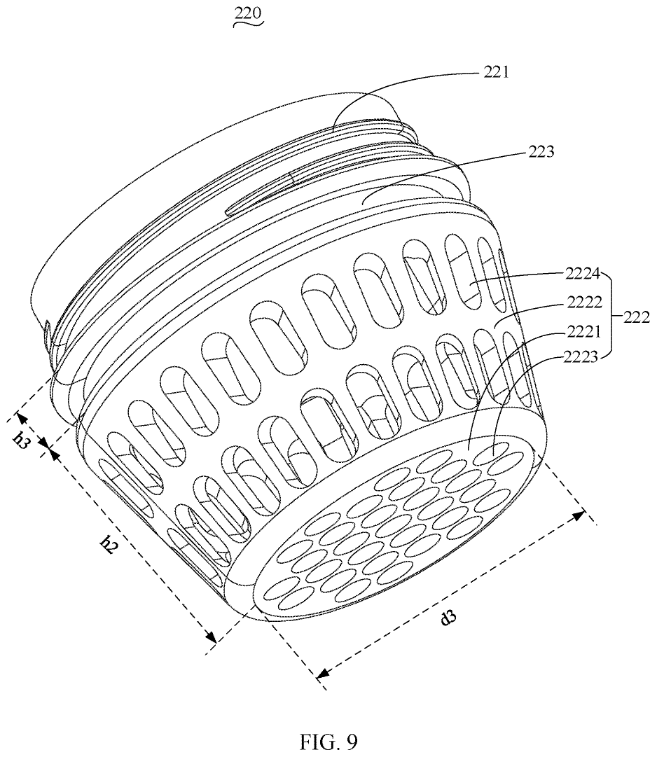

Referring to FIG. 9, FIG. 10, and FIG. 11, in a first implementation of the filtration segment 222, the filtration segment 222 includes a first filtration bottom wall 2221 and a first filtration side wall 2222, and the first filtration side wall 2222 extends from a circumferential edge of the first filtration bottom wall 2221 to the sealing segment 223. The plurality of filter holes formed in the filtration segment 222 include a plurality of first filter holes 2223 formed in the first filtration bottom wall 2221 and in communication with the second concave cavity 224 and a plurality of second filter holes 2224 formed in the first filtration side wall 2222 and in communication with the second concave cavity 224. In other words, the first filtration bottom wall 2221 is provided with a plurality of first filter holes 2223, and the first filtration side wall 2222 is provided with a plurality of second filter holes 2224. In this implementation, filter holes are provided in both the first filtration bottom wall 2221 and the first filtration side wall 2222 of the filtration segment 222, which can increase the filtration area of the filtration head 220 and reduce the weight and material consumption of the filtration head 220. Of course, in specific applications, in an alternative implementation, the plurality of filter holes formed in the filtration segment 222 may include only a plurality of first filter holes 2223 formed in the first filtration bottom wall 2221 and in communication with the second concave cavity 224, or may include only a plurality of second filter holes 2224 formed in the first filtration side wall 2222 and in communication with the second concave cavity 224, i.e., filter holes is provided in only one of the first filtration bottom wall 2221 and the first filtration side wall 2222.

In the first implementation of the filtration segment 222, a diameter of the first filtration side wall 2222 gradually increases in a direction from the circumferential edge of the first filtration bottom wall 2221 to the sealing segment 223. In other words, an outer diameter of the filtration segment 222 gradually decreases from top to bottom, a top of the filtration segment 222 is the part with the largest outer diameter of the filtration segment 222, and a bottom of the filtration segment 222 is the part with the smallest outer diameter of the filtration segment 222. The inner diameter of the top of the first concave cavity 2021 is greater than the outer diameter d3 of the bottom of the filtration segment 222 and is greater than or equal to the outer diameter d4 of the filtration segment 222, and the inner diameter d1 of the bottom of the first concave cavity 2021 is smaller than the outer diameter d3 of the bottom of the filtration segment 222. In this implementation, the configuration of the filtration segment 222 to have a conical shape with a large top and a small bottom can guide the insertion of the filtration head 220 into the paper filter 202 and guide the insertion of the filtration assembly 200 into the cup body 100. Of course, in specific applications, in an alternative implementation, the shape of the filtration segment 222 is not limited thereto. For example, in an alternative implementation, the diameter of the first filtration side wall 2222 is constant in the direction from the circumferential edge of the first filtration bottom wall 22221 to the sealing segment 223, i.e., the filtration segment 222 is of a cylindrical shape. Alternatively, in other alternative implementations, the filtration segment 222 may also be configured to be spherical or have other irregular shapes.

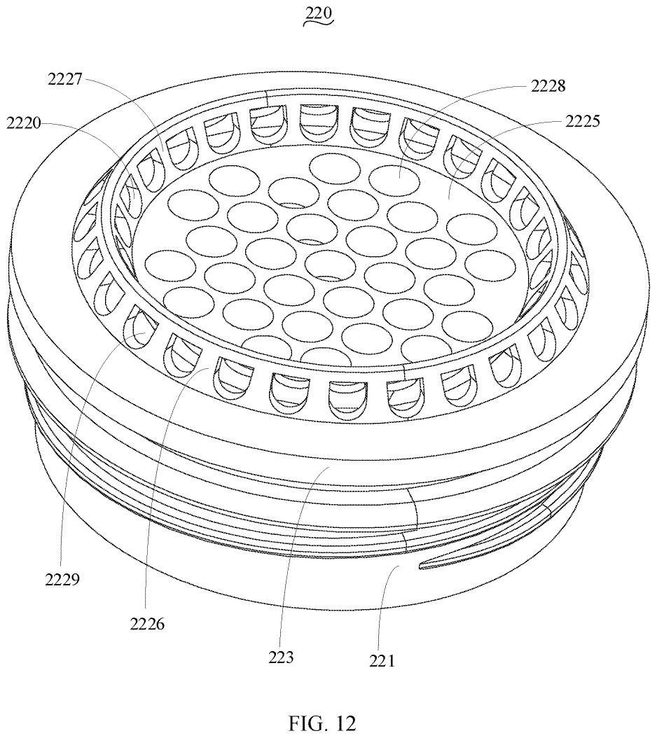

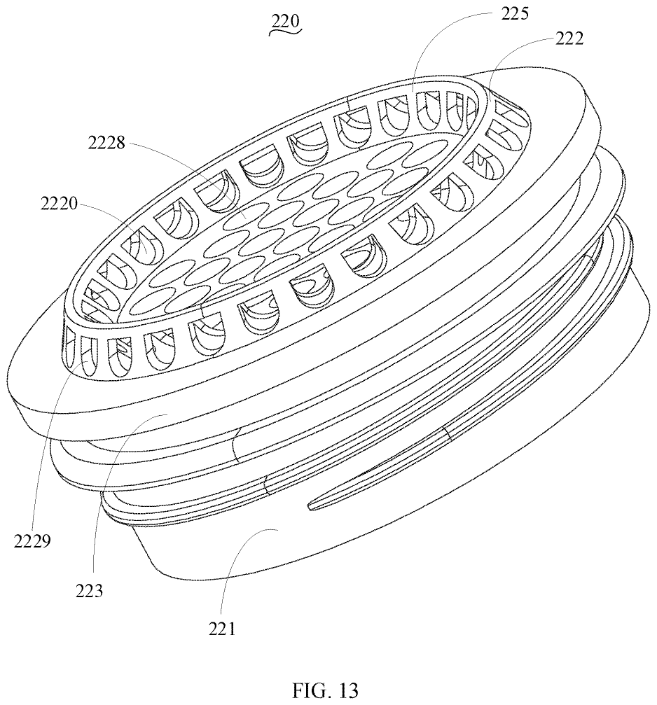

Referring to FIG. 3 and FIG. 12 to FIG. 14, in a second implementation of the filtration segment 222, the filtration head 220 is further provided with a second concave cavity 224 and a third concave cavity 225. The second concave cavity 224 is recessed relative to the connecting segment 221 and extends from the connecting segment 221 to the sealing segment 223 and the filtration segment 222, and the third concave cavity 225 is recessed at the bottom of the filtration segment 222. In other words, the second concave cavity 224 is recessed downward from the top of the filtration head 220, and the third concave cavity 225 is recessed upward from the bottom of the filtration head 220. The second concave cavity 224 is provided with a second opening facing upward, and the third concave cavity 225 is provided with a third opening facing downward. The filtration segment 222 includes a second filtration bottom wall 2225, a second filtration side wall 2226, and a third filtration side wall 2227. The second filtration side wall 2226 forms an outer circumferential wall of the filtration segment. The second filtration bottom wall 2225 and the third filtration side wall 2227 define the third concave cavity 225. The third filtration side wall 2227 extends from a bottom end of the second filtration side wall 2226 toward the second concave cavity 224 to a circumferential edge of the second filtration bottom wall 2225. The plurality of filter holes in the filtration segment 222 includes a plurality of third filter holes 2228 formed in the second filtration bottom wall 2225 and in communication with the second concave cavity 224, a plurality of fourth filter holes 2229 formed in the second filtration side wall 2226 and in communication with the second concave cavity 224, and a plurality of fifth filter holes 2220 formed in the third filtration side wall 2227 and in communication with the second concave cavity 224. The second filtration bottom wall 2225 and the third filtration side wall 2227 are located on an inner side of the second filtration side wall 2226 in a radial direction of the filtration segment 222. The third filtration side wall 2227 is spaced apart from the second filtration side wall 2226 except that a bottom end of the third filtration side wall 2227 is connected to the bottom end of the second filtration side wall 2226, i.e., the third filtration side wall 2227 and the second filtration side wall 2226 are not the same side wall. In this implementation, the third concave cavity 225 is recessed upward from the bottom of the filtration head 220, filter holes are provided in both an inner side wall of the third concave cavity 225 (i.e., the third filtration side wall 2227) and a bottom wall of the third concave cavity 225 (i.e., the second filtration bottom wall 2225), and filter holes are also provided in an outer side wall of the filtration segment 222 (i.e., the second filtration side wall 2226). In other words, the third concave cavity 225 is recessed upward, so that one more side wall (i.e., the third filtration side wall 2227) with filter holes is provided, thereby ensuring that the filtration segment 222 can form a sufficiently large filtration area, and reducing the height of the filtration segment 222. Compared with the first implementation of the filtration segment 222, in this implementation, the size of the space defined by the outer side wall of the filtration segment 222 and the inner side wall of the cup body 100 can be reduced, which can reduce the accumulation of liquid in the space defined by the outer side wall of the filtration segment 222 and the inner side wall of the cup body 100, thereby improving the drying and compaction effect obtained by pressing the residue.

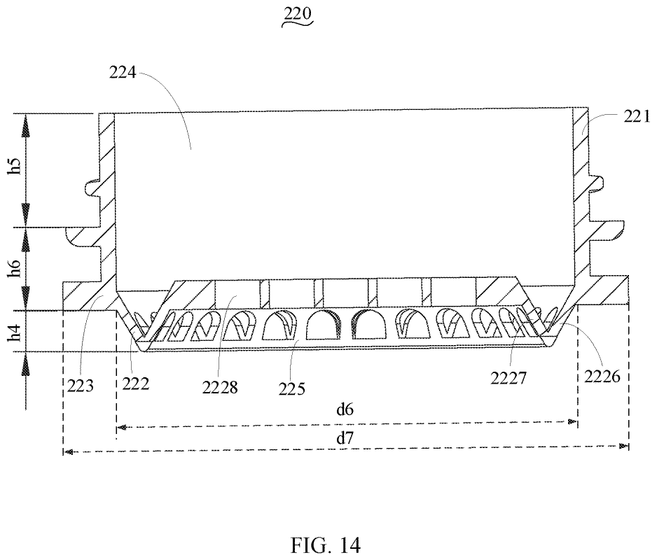

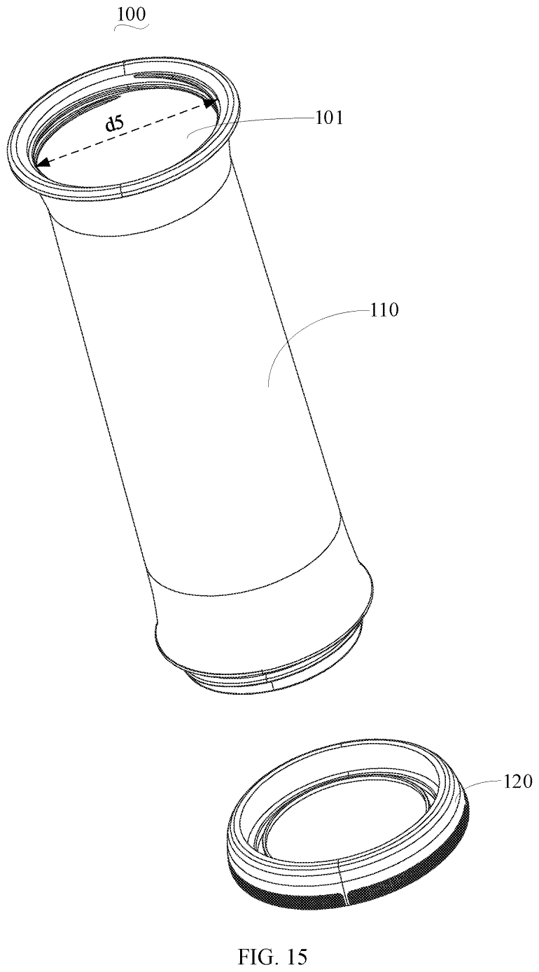

Referring to FIG. 3 and FIG. 14, in the second implementation of the filtration segment 222, a height h4 of the filtration segment 222 is smaller than or equal to a height h5 of the connecting segment 221. The height h4 of the filtration segment 222 is a vertical distance between a top end and the bottom end of the second filtration side wall 2226, i.e., an axial length of the filtration segment 222. The height h5 of the connecting segment 221 is a vertical distance between a top end and a bottom end of the connecting segment 221, i.e., an axial length of the connecting segment 221. In this implementation, the height h4 of the filtration segment 222 is controlled to be relatively small, which can further reduce the size of the space defined by the outer side wall of the filtration segment 222 and the inner side wall of the cup body 100, thereby further improving the drying and compaction effect obtained by pressing the residue.

Referring to FIG. 14, in an implementation, the height h4 of the filtration segment 222 is smaller than or equal to a height h6 of the sealing segment 223. The height h6 of the sealing segment 223 is a vertical distance between a top end and a bottom end of the sealing segment 223, i.e., an axial length of the sealing segment 223. In this implementation, the height h4 of the filtration segment 222 is controlled to be smaller, thereby further improving the drying and compaction effect obtained by pressing the residue.

Referring to FIG. 3 and FIG. 14, in an implementation, a maximum outer diameter d6 of the second filtration side wall 2226 is smaller than an outer diameter d7 of an end portion of the sealing segment 223 away from the connecting segment 221, i.e., the maximum outer diameter d6 of the second filtration side wall is smaller than an outer diameter of the bottom end of the sealing segment 223. In this way, the second filtration side wall 2226 does not extend downward from an outer edge of the bottom end of the sealing segment 223, but extends downward from a portion of a bottom wall of the sealing segment 223 which is spaced apart from the outer edge of the bottom wall of the sealing segment 223 by a spacing. As such, the filtration member 201 can be better placed on the paper filter 202, and the paper filter 202 can better wrap the filtration segment 222 and the first sealing ring 400 while being pressed downward. Of course, in specific applications, in an alternative implementation, the maximum outer diameter d6 of the second filtration side wall 2226 may be configured to be equal to the outer diameter d7 of the end portion of the sealing segment 223 away from the connecting segment 221.

In an implementation, a diameter of the second filtration side wall 2226 gradually decreases in a direction from the bottom wall of the sealing segment 223 away from the connecting segment 221. In other words, the second filtration side wall 2226 is a conical structure with a large top and a small bottom, so that the filtration head 220 can be better placed on the paper filter 202. Of course, in specific applications, the shape of the second filtration side wall 2226 is not limited thereto. For example, in an alternative implementation, the diameter of the second filtration side wall 2226 is constant in the direction from the bottom wall of the sealing segment 223 away from the connecting segment 221, i.e., the second filtration side wall 2226 is of a cylindrical shape.

In an implementation, a diameter of the third filtration side wall 2227 gradually decreases in a direction from the bottom end of the second filtration side wall 2226 of the sealing segment 223 to the circumferential edge of the second filtration bottom wall, i.e., the third filtration side wall 2227 is a conical structure with a large top and a small bottom. As such, a large spacing can be formed between the second filtration side wall 2226 and the third filtration side wall 2227, making it easier to respectively form filter holes in the second filtration side wall 2226 and the third filtration side wall 2227. A cross-section of the second filtration side wall 2226 and a cross-section of the third filtration side wall 2227 are of an inverted V-shape. Of course, in specific applications, the shape of the third filtration side wall 2227 is not limited thereto. For example, in an alternative implementation, the diameter of the third filtration side wall 2227 is constant in the direction from the bottom end of the second filtration side wall 2226 of the sealing segment 223 to the circumferential edge of the second filtration bottom wall, i.e., the third filtration side wall 2227 is of a cylindrical shape.

In an implementation, a distribution area of the plurality of filter holes of the filtration segment 222 (i.e., all the filter holes of the filtration segment 222) is greater than or equal to 20% of a surface area of the filtration segment 222. This ensures that the filtration segment 222 has a sufficiently large filtration, reducing the force required for a user to press the pushing member 320 downward.

In an implementation, the distribution area of the plurality of filter holes of the filtration segment 222 is greater than or equal to 32% of the surface area of the filtration segment, which is conducive to further improving the filtration efficiency and the smoothness of pressing the pushing member downward.

In an implementation, the distribution area of the plurality of filter holes of the filtration segment 222 is greater than or equal to 45% of the surface area of the filtration segment, which is conducive to further improving the filtration efficiency and the smoothness of pressing the pushing member downward.

In an implementation, a first annular groove is provided on an outer side wall of the sealing segment 223, and the first sealing ring 400 is engaged with the first annular groove.

In an implementation, the connecting segment 221 is provided with external threads, and the bottom end of the cylinder 210 is provided with internal threads, and the connecting segment 221 is threadedly connected to the cylinder 210.

Referring to FIG. 3, FIG. 8, and FIG. 15, in an implementation, a maximum outer diameter d2 of the paper filter 202 is greater than an inner diameter d5 of the first opening 101, i.e., an outer diameter of a top of the paper filter 202 is greater than the inner diameter d5 of the first opening 101. In this way, when the paper filter 202 is just placed on the cup body 100, the paper filter 202 does not completely enter the accommodating chamber 103 of the cup body 100, making the placement of the paper filter 202 more error-tolerant.

Referring to FIG. 3, FIG. 4, FIG. 5, and FIG. 8, in an implementation, a flange 2025 extending outward is provided at an edge of the top of the paper filter 202, and the flange 2025 is configured to overlap an edge of the top of the cup body 100 (i.e., an edge of the first opening) before the pushing member 320 pushes the filtration member 201 and the paper filter 202 to move toward the sealed portion 102. Specifically, the paper filter 202 includes a paper body 2027 and a flange 2025, and the flange 2025 is an annular structure extending horizontally from an edge of a top of the paper body in a direction away from a central axis of the paper body 2027. An outer diameter of the flange 2025 is the maximum outer diameter d2 of the paper filter 202. The configuration of the flange 2025 allows for a user to place the paper filter 202 on the top edge of the cup body 100 at will without worrying about the position of the paper filter 202, and ensures that no matter how the user places the paper filter 202, the paper filter 202 can well overlap the edge of the top of the cup body 100, making the placement of the paper filter 202 more error-tolerant. In other words, when the paper filter 202 overlaps the top of the cup body 100, the flange 2025 enables the user to easily cause the paper filter 202 to fall to a proper position, making it more convenient for the user to use the brewing cup 10 and reducing the difficulty of using the brewing cup 10 for the user, and also enables the paper filter 202 to better wrap the first sealing ring 400.

In an implementation, the paper body 2027 is of a conical shape, and a diameter of the paper body 2027 gradually decreases from top to bottom. In other words, the paper body 2027 is a conical structure with a large top and a small bottom, so that the paper filter 202 can more smoothly overlap the edge of the top of the cup body 100.

In an implementation, an outer diameter of the cylinder 210 is equal to an inner diameter of the accommodating chamber 103. As such, the cylinder 210 is in contact with the inner side wall of the accommodating chamber 103 after being inserted into the accommodating chamber 103. Of course, in specific applications, there may be a certain spacing between the cylinder 210 and the accommodating chamber 103.

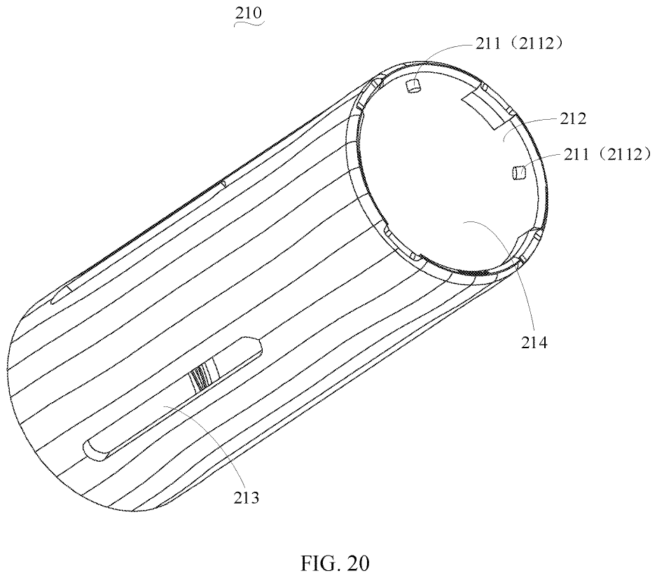

Referring to FIG. 18 and FIG. 20, in an implementation, the cylinder 210 is further provided with an elongated opening 213 extending from an outer side wall to the inner side wall of the cylinder 210, to strengthen the cylinder 210.

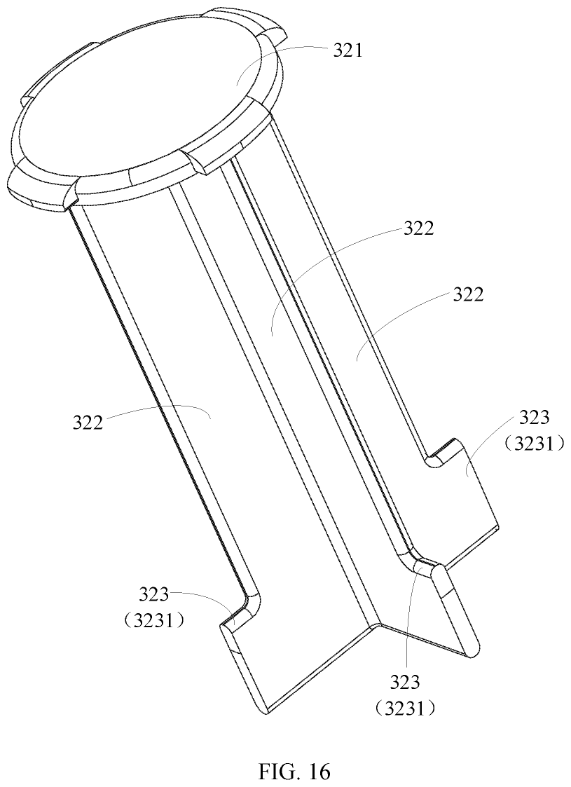

Referring to FIG. 16 to FIG. 20, in an implementation, at least two first pressing portions 211 spaced apart in a circumferential direction of the cylinder 210 are formed protruding from the inner side wall of the cylinder 210. At least two second pressing portions 323 spaced apart in a circumferential direction of the pushing member 320 are formed on an outer circumferential side of the pushing member 320. when the second pressing portions 323 are respectively opposite to and press against the first pressing portions 211, the pushing member 320 is configured to push, under an external force, the cylinder 210 to drive the filtration head 220 and the paper filter 202 to move in the direction from the first opening 101 to the sealed portion 102. In this implementation, a press fit between the pushing member 320 and the filtration member 201 is realized by a press fit between the second pressing portions 323 and the first pressing portions 211, and a bottom of the pushing member 320 can be supported by tops of the first pressing portions 211. In this case, the pushing member 320 can push the first pressing portions 211 under an external force to drive the cylinder 210 to move downward. The first pressing portions 211 may be protruding blocks, protrusions 2112, stepped surfaces, ribs, or the like protruding from the inner side wall of the cylinder 210.

In an implementation, a number of the first pressing portions 211 is an integer multiple of a number of the second pressing portions 323, and the integer multiple is greater than or equal to one. In other words, the number of the first pressing portions 211 may be equal to the number of the second pressing portions 323, or may be two times or any higher integer multiple thereof. For example, the number of the first pressing portions 211 and the number of the second pressing portions 323 may both be four, three, two, five, six or more. For another example, the number of the first pressing portions 211 is four, and the number of the second pressing portions 323 is two. For another example, the number of the first pressing portions 211 is six, and the number of the second pressing portions 323 is three.

In an implementation, a spacing exists between the first pressing portion 211 and an end portion of the cylinder 210 away from the filtration head 220, i.e., a spacing exists between the first pressing portion 211 and a top of the cylinder 210, and the first pressing portion 211 is not even with an edge of the top of the cylinder 210. As such, when the second pressing portion 323 presses against the respective first pressing portion 211, the pushing member 320 is partially embedded in the cylinder 210. In this way, the pushing member 320 can be horizontally limited by the cylinder 210, to prevent the pushing member 320 from detaching from the filtration assembly 200 during the process of pushing the pushing member 320 to move toward the sealed portion 102, thereby ensuring the stability and reliability of the pushing member 320 pushing the filtration assembly 200 to move.

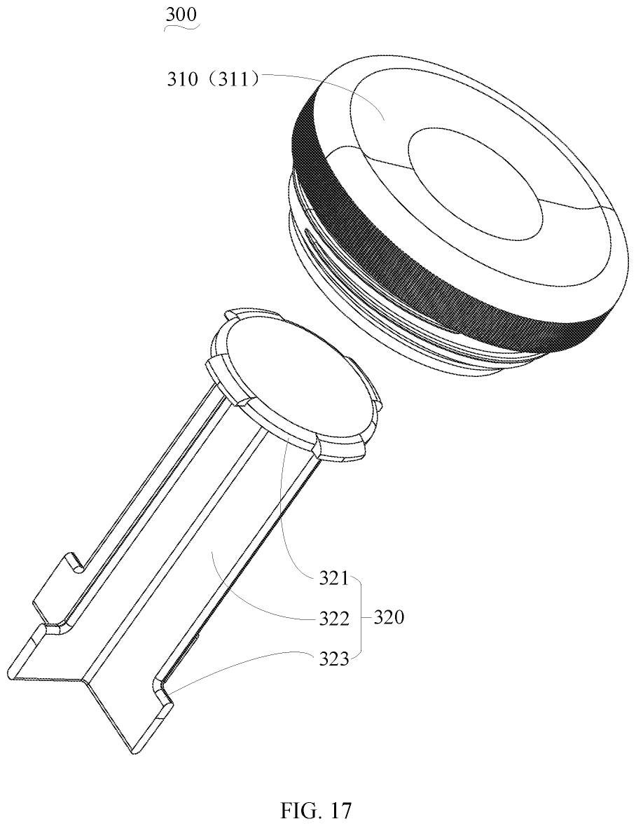

Referring to FIG. 2, FIG. 16, and FIG. 17, in a first implementation of the pushing member 320, the pushing member 320 includes a transverse plate 321 and at least two vertical plates 322. One end of the transverse plate 321 is connected to one end of the at least two vertical plates 322, i.e., a bottom surface of the transverse plate 321 is connected to a top end of each of the at least two vertical plates 322. Inner sides of the at least two vertical plates 322 adjacent to a central axis of the transverse plate 321 intersect each other, and outer peripheral sides of the at least two vertical plates 322 away from the central axis of the transverse plate 321 are arranged at intervals in a circumferential direction of the transverse plate 321. Each vertical plate 322 is provided with the respective second pressing portion 323 protruding from the outer peripheral side thereof away from the central axis of the transverse plate 321, and each of the second pressing portions 323 is arranged adjacent to an end portion of the respective vertical plate 322 away from the transverse plate 321. In other words, the at least two vertical plates 322 radially extend outward from an intersection plane of the vertical plates 322. The configuration of the at least two vertical plates 322 mainly facilitates the fitting with the filtration assembly 200, and reduces the material consumption and weight of the pushing member 320. In an alternative embodiment, the transverse plate 321 may also be configured in a rod shape.

Referring to FIG. 16 to FIG. 18, in an implementation, each of the first pressing portions 211 is a first protruding block 2111 extending in an arc shape in a circumferential direction of the inner side wall of the cylinder 210. Each of the second pressing portions 323 is a second protruding block 3231 extending from an end portion of the respective vertical plate 322 away from the transverse plate 321 and protruding from the outer peripheral side of the respective vertical plate 322. A circumferential extending length of the second protruding block 3231 is greater than a circumferential extending length of the respective first protruding block 2111, and the second protruding block 3231 is configured to press against the respective first protruding block 2111, so that the second pressing portion 323 presses against the first pressing portion 211. The circumferential extending length of the first protruding block 2111 is a dimension of the first protruding block 2111 extending horizontally in the circumferential direction. The circumferential extending length of the second protruding block 3231 is a dimension of the second protruding block 3231 extending horizontally in the circumferential direction. In this implementation, the circumferential extending length of the second protruding block 3231 is configured to be greater than the circumferential extending length of the first protruding block 2111, to prevent the first protruding block 2111 from easily detaching from the second protruding block 3231.

In an implementation, the number of vertical plates 322 is four, and each vertical plate 322 is provided with a second protruding block 3231 on an outer peripheral side thereof. Of course, in specific applications, the number of vertical plates 322 is not limited to four. For example, in an alternative implementation, the number of vertical plates 322 is three; or the number of vertical plates 322 is two; or the number of vertical plates 322 is five, six, or more.

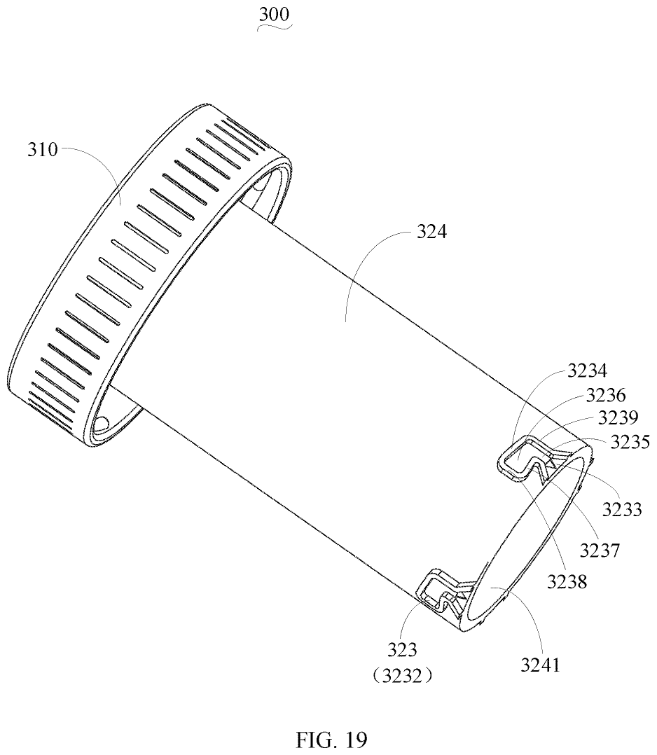

In the first implementation of the pushing member 320, the pushing member 320 includes the transverse plate 321 and the at least two vertical plates 322, and each second pressing portion 323 is a protruding block protruding from the outer peripheral side of the respective vertical plate 322. Of course, in specific applications, the configurations of the pushing member 320 and the second pressing portions 323 are not limited thereto. For example, referring to FIG. 19, in a second implementation of the pushing member 320, the pushing member 320 includes a rod 324, and the rod 324 is provided with the second pressing portions 323 protruding from an outer side wall thereof. In this implementation, the pushing member 320 is a rod, and has a simple structure.

Referring to FIG. 2, FIG. 19, and FIG. 20, in a further implementation of the second implementation of the pushing member 320, each of the first pressing portions 211 is a protrusion 2112 protruding from the inner side wall of the cylinder 210. Each of the second pressing portions 323 is a slot 3232, the slot 3232 is provided with a slot opening 3233 facing the sealed portion 102 and a first slot wall 3234 spaced apart from and opposite to the slot opening 3233, and the protrusion 2112 is configured to be engaged in the respective slot 3232 and press against the first slot wall 3234, so that the second pressing portion 323 presses against the first pressing portion 211. In this implementation, the engagement of the protrusions 2112 with the slots 3232 can not only realize a press fit between the first pressing portion 211 and the second pressing portion 323, but also prevent the first pressing portions 211 from detaching from the second pressing portions 323.

In an implementation, the protrusions 2112 are cylindrical protrusion 2112, which have a simple structure and are easy to manufacture. Of course, the shape of the protrusions 2112 is not limited thereto. For example, in an alternative implementation, the protrusions 2112 may be semi-cylindrical protrusions 2112, rectangular protrusions 2112, etc.

Referring to FIG. 2, FIG. 19, and FIG. 20, in an implementation, the slot 3232 includes a mounting slot segment 3235 and a locking slot segment 3236, the mounting slot segment 3235 extends from the slot opening 3233 toward the first slot wall 3234, and the locking slot segment 3236 extends horizontally from the mounting slot segment 3235. The slot 3232 is further provided with a second slot wall 3237, a third slot wall 3238, and a fourth slot wall 3239. The first slot wall 3234 is spaced apart from and opposite to the second slot wall 3237. The third slot wall 3238 is spaced apart from and opposite to the fourth slot wall 3239. The third slot wall 3238 is connected to one end of the first slot wall 3234 and one end of the second slot wall 3237. The first slot wall 3234, the second slot wall 3237, and the third slot wall 3238 jointly define the locking slot segment 3236. The protrusions 2112 and the slots 3232 are assembled in the following manner. The protrusion 2112 is slid into the mounting slot segment 3235 from the slot opening 3233, and then is transversely engaged into the locking slot segment 3236 from the mounting slot segment 3235, thereby preventing the protrusion 2112 from easily detaching from the slot 3232.

Referring to FIG. 2 and FIG. 19, in an implementation, the rod 324 is provided with an inner hole 3241 along a central axis thereof, i.e., the rod 324 is a hollow rod, to reduce the weight and material consumption of the pushing member 320.

Referring to FIG. 1, FIG. 2, FIG. 17, and FIG. 19, in an implementation, the brewing cup 10 further includes a top lid 310 separably connected to the cup body 100. When the top lid 310 is connected to the cup body 100, the top lid 310 closes and seals the first opening 101 and defines a sealed space with the cup body 100. In this implementation, through the configuration of the top lid 310 to close and seal the first opening 101 of the cup body 100 and define a sealed space with the cup body 100, when the brewing cup 10 is filled with liquid, the liquid will not leak out through the first opening 101 at the top of the brewing cup 10 even if the brewing cup 10 is inverted. Therefore, the brewing cup 10 can not only be used to brew the brewing powder into a drinkable liquid, but also can be used as a portable liquid storage container for containing a drinking liquid. Thus, the functions of the brewing cup 10 are effectively expanded. In addition, the top lid 310 closes and seals the cup body 100, so that the brewing cup 10 can be sealed to form a sealed space. As such, in specific applications, after putting the brewing powder and the liquid solvent into the cup body 100, a user may first cover the sealed cup body 100 with the top lid 310, and then shake the brewing cup 10 to mix the brewing powder and the liquid solvent, so that the brewing powder and the liquid solvent can be mixed more quickly and fully. The mixing operation does not require the use of other tools, which is simple and convenient. When the brewing cup 10 is used for making coffee, sufficient mixing of the brewing powder and the liquid solvent is conducive to increasing the concentration of the coffee and improving the taste.

In an implementation, after adding the brewing powder and the liquid solvent into the cup body 100, the user shakes the brewing cup 10 to uniformly mix the brewing powder and the liquid solvent. The shaking-based mixing method can improve the extraction efficiency compared with a stirring-based mixing method, especially in the preparation process of cold brew coffee. The coffee making process can be completed in one minute. In a specific application, after adding the brewing powder and the liquid solvent into the cup body 100, the user first closes the top lid 310 to seal the first opening 101 before shaking the brewing cup 10 to uniformly mix the brewing powder and the liquid solvent, so as to prevent the liquid from being ejected from the cup body 100 during the shaking process.

In an implementation, an end portion of the pushing member 320 away from the sealed portion 102 is separably connected to the top lid 310, i.e., the end portion of the pushing member 320 away from the sealed portion 102 is detachably connected to the top lid 310, so that the pushing member 320 can be connected to the top lid 310 or can be detached and removed from the top lid 310 to achieve separation from the top lid 310. The pushing member 320 may be connected to the top lid 310 to form the top lid assembly 300. In a specific application, after adding the brewing powder and the liquid solvent into the cup body 100 and before shaking the brewing cup 10 to uniformly mix the brewing powder and the liquid solvent, the user first detaches and removes the pushing member 320 from the top lid 310, and separately closes the top lid 310 to seal the first opening 101. After shaking the brewing cup 10 to uniformly mix the brewing powder and the liquid solvent, the user removes the top lid 310, places the filtration assembly 200 at the top end of the cup body 100, assembles the pushing member 320 to the top lid 310 to form the top lid assembly 300, and attaches the top lid assembly 300 to the filtration assembly 200. By this method, the pushing member 320 can be prevented from being contaminated during the shaking and mixing process, thereby reducing the difficulty of cleaning the pushing member 320. Further, when the filtration assembly 200 is attached to the cup body 100 and the pushing member 320 presses against the filtration assembly 200, the user may apply a force to a top of the top lid 310 to drive the pushing member 320 to push the filtration assembly 200 to move toward the inside of the accommodating chamber 103. Of course, in specific applications, in an alternative implementation, the push rod and the top lid 310 may be integrally formed.

In an implementation, the end portion of the pushing member 320 away from the sealed portion 102 (i.e., the top of the pushing member 320) is detachably connected to the top lid 310 by a rotary snap-fit or threaded connection.

In an implementation, the top lid assembly 300 formed by assembling the pushing member 320 to the top lid 310 is configured to drive, under an external force, the filtration assembly 200 to move relative to the cup body 100. In other words, the user pushes the filtration assembly 200 to move downward by pressing the top lid 310 and the pushing member 320 to move downward instead of pressing the pushing member 320 alone. As such, the top lid 310 can increase the contact area of the user's hand during pressing, making it more comfortable and convenient for the user to operate and use the brewing cup 10. In a specific application, when needing to brew the brewing powder with the brewing cup 10, a user may first detach and remove the filtration assembly 200 and the top lid assembly 300 from the cup body 100, respectively add the brewing powder and the liquid solvent into the cup body 100, and after the brewing powder and the liquid solvent are fully mixed, places the filtration assembly 200 on a top end of the cup body 100. Then, the user may attach the top lid assembly 300 to the filtration assembly 200, and then press the top lid assembly 300 to drive the filtration assembly 200 to move toward the sealed portion 102 of the cup body 100, causing the filtration assembly 200 to push the residue in the mixture in the cup body 100 toward a bottom of the cup body 100. After the filtration assembly 200 is moved into place, the user may detach and remove the top lid assembly 300. In this case, since the filtration assembly 200 is still located in the cup body 100 to maintain the separation of the liquid from the residue, the user may directly use the cup body 100 to drink the brewed liquid. As such, the brewing cup 10 can be used as both a brewing device and a drinking container, which obviates the need for an additional container, making it more convenient for the user to brew the brewing powder and drink the brewed liquid.

Referring to FIG. 1, FIG. 2, and FIG. 17, in an implementation, the top lid 310 is provided with a gripping portion 311 for a user to grip, so as to push the pushing member 320 to drive the filtration assembly 200 to move in a direction from the first opening 101 to the sealed portion 102. An outer diameter of the gripping portion 311 is greater than or equal to 50% of the inner diameter of the first opening 101. In this implementation, a gripping portion 311 having an outer diameter greater than or equal to 50% of the inner diameter of the first opening 101 is formed on the top lid 310, so that the user can grip the gripping portion 311 to presses the top lid assembly 300 to move, which greatly increases the contact area of the user's hand in comparison with the method of operating a French press by pressing a small ball.

In an implementation, the outer diameter of the gripping portion 311 is greater than or equal to 60% of the inner diameter of the first opening 101.

In an implementation, the outer diameter of the gripping portion 311 is greater than or equal to 80% of the inner diameter of the first opening 101.

In an implementation, the outer diameter of the gripping portion 311 is greater than or equal to the inner diameter of the first opening 101.

In an implementation, the outer diameter of the gripping portion 311 is substantially equal to the inner diameter of the first opening 101, so that the contact area of the user's hand when pressing the top lid assembly 300 to move can be maximized while ensuring the performance of the top lid 310 in covering the first opening 101, thereby making it more comfort for the user to press the top lid assembly 300 to move.

Referring to FIG. 2 and FIG. 5, in an implementation, the brewing cup 10 further includes a second sealing ring 500 arranged between the top lid 310 and the cup body 100 to seal a fitting gap between the top lid 310 and the cup body 100 when the top lid 310 is connected to and closes the cup body 100. The configuration of the second sealing ring 500 ensures that when the top lid 310 is connected to and closes the cup body 100, the top lid 310 and the cup body 100 can define a sealed space, so that the liquid in the brewing cup 10 will not leak out through the first opening 101 even if the brewing cup 10 is inverted. In addition, while the brewing cup 10 is being shaken to uniformly mix the brewing powder and the liquid solvent, the liquid in the brewing cup 10 will not leak out through the first opening 101, allowing the user to shake the brewing cup 10 to uniformly mix the brewing powder and the liquid solvent.

In an implementation, the top lid 310 is provided with a second annular groove, and the second sealing ring 500 is engaged with the second annular groove.

Referring to FIG. 1 to FIG. 3, in an implementation, the pushing member 320 has a first mounted state and a second mounted state. In the first mounted state, the pushing member 320 is in nested fit with the filtration assembly 200, so that the pushing member 320 and the filtration assembly 200 can be received in the sealed space. When the pushing member 320 is in the second mounted state, the pushing member 320 presses against the filtration assembly 200 in the direction from the first opening 101 to the sealed portion 102, and the pushing member 320 is at least partially exposed out of the accommodating chamber 103. As such, under an external force, the pushing member 320 may push the filtration assembly 200 to move in a direction from the first opening 101 to the sealed portion 102, causing the paper filter 202 to push the residue in the mixture in the accommodating chamber 103 toward the sealed portion 102, and causing the liquid in the mixture to pass through the paper filter 202 into the space between the paper filter 202 and the first opening 101. The pushing member 320 is arranged protruding from a side of the top lid 310 facing the sealed portion 102. In the first mounted state, the top lid 310 is connected to the cup body 100 and seals the first opening 101. When the pushing member 320 is in the second mounted state, the top lid 310 is spaced apart from the cup body 100. In this implementation, the configuration of the pushing member 320 to have the first mounted state and the second mounted state can meet different usage requirements of the brewing cup 10. Specifically, because the pushing member 320 is in nested fit with the filtration assembly 200 when the pushing member 320 is in the first mounted state, the pushing member 320 and the filtration assembly 200 can be received in the sealed space defined by the top lid 310 and the cup body 100, which is conducive to reducing the volume of the brewing cup 10. Therefore, when the pushing member 320 is in the first mounted state, the portability of the brewing cup 10 is improved. Because the pushing member 320 presses against the filtration assembly 200 in the direction from the first opening 101 to the sealed portion 102 when the pushing member 320 is in the second mounted state, the pushing member 320 can push, under an external force, the filtration assembly 200 to move toward the sealed portion 102. Therefore, when the pushing member 320 is in the second mounted state, the brewing cup 10 can be used to brew the brewing powder. After the pushing member 320 pushes the filtration assembly 200 to move into place, the user may detach and remove the top lid 310 and the pushing member 320. In this case, since the filtration assembly 200 is still located in the cup body 100 to maintain the separation of the liquid from the residue, the user may directly use the cup body 100 to drink the brewed liquid. As such, the brewing cup 10 can be used as both a brewing device and a drinking container, which obviates the need for an additional container, making it more convenient for the user to use the brewing cup 10.

Referring to FIG. 1, FIG. 2, and FIG. 5, in an implementation, in the first mounted state, the pushing member 320 is engaged and received in the cylinder 210; and in the second mounted state, the pushing member 320 presses against the cylinder 210 in the direction from the first opening 101 to the sealed portion 102, and the end portion of the pushing member 320 away from the sealed portion 102 is exposed out of the cylinder 210.

Referring to FIG. 1, FIG. 2, FIG. 3, and FIG. 5, in an implementation, in the first mounted state, a distance between the end portion of the pushing member 320 away from the sealed portion 102 and an end portion of the filtration assembly 200 adjacent to the sealed portion 102 is smaller than a depth of the accommodating chamber 103, and both the pushing member 320 and the filtration assembly 200 are received in the accommodating chamber 103. When the pushing member 320 is in the second mounted state, the distance between the end portion of the pushing member 320 away from the sealed portion 102 and the end portion of the filtration assembly 200 adjacent to the sealed portion 102 is greater than the depth of the accommodating chamber 103, and the end portion of the pushing member 320 away from the sealed portion 102 is exposed out of the accommodating chamber 103. In this case, the top lid 310 and at least part of the pushing member 320 are exposed out of the cup body 100, allowing the user to grip the top lid 310 and press the top lid 310 downward to push the pushing member 320 and the filtration assembly 200 to move.

Referring to FIG. 2 and FIG. 16 to FIG. 20, in an implementation, at least two first pressing portions 211 spaced apart in a circumferential direction of the cylinder 210 are formed on the cylinder 210, and a clearance space 212 is formed between any two neighboring first pressing portions 211. At least two second pressing portions 323 spaced apart in a circumferential direction of the pushing member 320 are formed on the pushing member 320. The pushing member 320 is in nested fit with the cylinder 210, so that each of the second pressing portions 323 is directly opposed to one of the clearance spaces 212 and moves through the clearance space 212 toward the sealed portion 102. The pushing member 320 presses against the cylinder 210, so that each of the second pressing portions 323 is directly opposed to and presses against one of the first pressing portions 211. In this implementation, both the number of the first pressing portions 211 and the number of the clearance spaces 212 are at least two, and the at least two first pressing portions 211 and the at least two clearance spaces 212 are alternately distributed in a horizontal circumferential direction of the filtration assembly 200. The pushing member 320 may be mounted to the cup body 100 with the second pressing portions 323 respectively facing and pressing against the first pressing portions 211, thus achieving a mounting effect in the second mounted state. The second pressing portion 323 may also be mounted to the cup body 100 with the second pressing portions 323 respectively facing and passing through the clearance spaces 212, thus achieving a mounting effect in the first mounted state. Because the pushing member 320 is in nested fit with the filtration assembly 200 when the pushing member 320 is in the first mounted state, the pushing member 320 and the filtration assembly 200 can be received in the sealed space defined by the top lid 310 and the cup body 100, which is conducive to reducing the volume of the brewing cup 10, thereby improving the portability of the brewing cup 10. In addition, when the pushing member 320 is in the first mounted state, the top lid 310 is sealedly connected to the cup body 100, so the brewing cup 10 can be used for containing a drinking liquid. Thus, the functions of the brewing cup 10 are effectively expanded.

In an implementation, a distance from the first pressing portion 211 to the end portion of the cylinder 210 away from the filtration head 220 is smaller than a distance from the first pressing portion 211 to an end portion of the cylinder 210 adjacent to the filtration head 220, i.e., a distance from the first pressing portion 211 to the edge of the top of the cylinder 210 is smaller than a distance from the first pressing portion 211 to an edge of a bottom of the cylinder 210. Such a configuration can reduce the length of the pushing member 320, and allows the cylinder 210 to have a sufficient length below the clearance spaces 212 for nesting with the pushing member 320 when the second pressing portions 323 respectively pass through the clearance spaces 212.

Referring to FIG. 2 and FIG. 16 to FIG. 18, in a specific implementation of the first implementation of the pushing member 320, the pushing member 320 includes a transverse plate 321 and at least two vertical plates 322, one end of the transverse plate 321 is connected to the top lid 310, and another end of the transverse plate 321 is connected to one end of the at least two vertical plates 322. Each of the first pressing portions 211 is a first protruding block 2111 extending in an arc shape in the circumferential direction of the inner side wall of the cylinder 210, and a spacing between any two neighboring first protruding blocks 2111 forms a clearance space 212. Each of the second pressing portions 323 is a second protruding block 3231 extending from an end portion of the respective vertical plate 322 away from the transverse plate 321 and protruding from the outer peripheral side of the respective vertical plate 322. A circumferential extending length of the second protruding block 3231 is greater than a circumferential extending length of the first protruding block 2111. When the pushing member 320 is in the second mounted state, a bottom of the second protruding block 3231 presses against a top of the first protruding block 2111.

Referring to FIG. 2 and FIG. 19 to FIG. 20, in a specific implementation of the second implementation of the pushing member 320, the pushing member 320 includes a rod 324, one end of the rod 324 is connected to the top lid 310, and the rod 324 is provided with the second pressing portions 323 protruding from an outer side wall thereof. Each of the first pressing portions 211 is a protrusion 2112 protruding from the inner side wall of the cylinder 210, and a spacing between any two neighboring protrusions 2111 forms a clearance space 212. Each of the second pressing portions 323 is a slot 3232. The slot 3232 is provided with a slot opening 3233 facing away from the top lid 310 and a first slot wall 3234 spaced apart from and opposite to the slot opening 3233. When the pushing member 320 is in the second mounted state, the protrusion 2112 is engaged in the slot 3232 and presses against the first slot wall 3234.

Referring to FIG. 1 to FIG. 5, and FIG. 15, in an embodiment, the cup body 100 includes a cylindrical body 110 and a bottom lid 120, one end of the cylindrical body 110 is provided with the first opening 101, the other end of the cylindrical body 110 is provided with a second opening, the bottom lid 120 is separably connected to the other end of the cylindrical body 110. When the bottom lid 120 is mounted to the cylindrical body 110, the bottom lid 120 closes and seals the second opening to form the sealed portion 102. Specifically, the bottom lid 120 is separably connected to the end of the cylindrical body 110 provided with the second opening, i.e., the bottom lid 120 is separably connected to a bottom of the cylindrical body 110. The detachable design of the bottom lid 120 makes it more convenient to clean the brewing cup 10 after use. In a specific application, when the brewing cup 10 needs to be cleaned after a brewing process is completed, a user may remove the bottom lid 120, press the top lid 310 downward to cause the pushing member 320 to push the filtration assembly 200 to move downward, so as to push the residue and the paper filter 203 out of the second opening at a bottom end of the cylindrical body 110. As such, the residue will not be adhered to the cylinder 210, the filtration head 220, and the pushing member 320. Theoretically, the user only needs to clean the bottom lid 120, which effectively reduces the difficulty of cleaning the brewing cup 10 and greatly improves user experience.

The above descriptions are merely preferred embodiments of the present disclosure, and are not intended to limit the patent scope of the present disclosure. Any equivalent structural transformation made based on the contents of the specification and drawings of the present disclosure, or the direct or indirect application of the present disclosure to other related technical fields without departing from the inventive concept of the present disclosure are all included in the protection scope of the present disclosure.

What is claimed is:

1. A brewing cup, comprising:
a cup body, provided with an accommodating chamber, wherein one end of the accommodating chamber is provided with a first opening which is open, another end of the accommodating chamber is provided with a sealed portion which is closed and is spaced apart from and opposite to the first opening, and the first opening is configured to allow a brewing powder and a liquid solvent to pass therethrough to enter the accommodating chamber;
a filtration assembly, comprising a filtration member and a paper filter, wherein the filtration member and the paper filter are respectively separably connected to the cup body, the filtration member and the paper filter are movably inserted in the accommodating chamber, and the paper filter is configured to be pushed by the filtration member to move from the first opening toward the sealed portion and wrap an end portion of the filtration member facing the sealed portion, and filter a mixture of the brewing powder and the liquid solvent in the accommodating chamber to separate residue from liquid in the mixture; and
a pushing member, configured to push, under an external force, the filtration member and the paper filter to move in a direction from the first opening to the sealed portion, causing the filtration member and the paper filter to push the residue in the mixture in the accommodating chamber toward the sealed portion, and causing the liquid in the mixture to pass through the paper filter into a space between the paper filter and the first opening.

2. The brewing cup of claim 1, wherein before the pushing member pushes the filtration member and the paper filter to move toward the sealed portion, the paper filter is laid on an edge of the first opening, the filtration member is vertically placed on the paper filter, and a spacing exists between the paper filter and a bottom of the filtration member facing the sealed portion; and
after the pushing member pushes the filtration member and the paper filter to move toward the sealed portion, a portion of the paper filter between the bottom of the filtration member and the sealed portion is partially laminated, presses against, and wraps the bottom of the filtration member.

3. The brewing cup of claim 2, wherein after the pushing member pushes the filtration member and the paper filter to move toward the sealed portion, a portion of the paper filter between the bottom of the filtration member and the sealed portion is compressed and folded to form a pleated structure composed of a laminated structure comprising at least two layers;
wherein the pleated structure forms three-dimensional channels at a bottom of the paper filter, with a height ranging from 0.2 mm to 1 mm.

4. The brewing cup of claim 1, wherein the pushing member is separably connected to the filtration member; or
the pushing member is telescopically connected to the filtration member.

5. The brewing cup of claim 1, wherein the filtration member comprises a cylinder and a filtration head, and the filtration head is assembled to or integrally formed on an end of the cylinder facing the sealed portion;
the paper filter is separably connected to the filtration head, and is configured to wrap the filtration head when the filtration member pushes the paper filter to move toward the sealed portion; and
the pushing member is separably connected to the cylinder, and is configured to push, under an external force, the cylinder to drive the filtration head and the paper filter to move in the direction from the first opening to the sealed portion;
wherein the filtration head is separably connected to the cylinder.

6. The brewing cup of claim 5, wherein the filtration head comprises a connecting segment, a sealing segment, and a filtration segment arranged in sequence in an axial direction thereof, the connecting segment is separably connected to the cylinder, and the filtration segment is provided with a plurality of filter holes for the liquid to pass through;
the brewing cup further comprises a first sealing ring, and the first sealing ring is sleeved over the sealing segment to seal a fitting gap between the sealing segment and an inner side wall of the accommodating chamber when the filtration assembly is inserted into the accommodating chamber; and
the paper filter is at least configured to wrap the filtration segment or wrap the filtration segment and the first sealing ring.

7. The brewing cup of claim 6, wherein the paper filter is provided with a first concave cavity, the first concave cavity is provided with a first cavity opening facing the first opening and a cavity bottom wall spaced apart from and opposite to the first cavity opening, and the paper filter wraps the filtration head or wrap the filtration segment and the first sealing ring with the first cavity opening facing the first opening; and the paper filter and the filtration head satisfy at least one of the following conditions: a minimum inner diameter of the first concave cavity is smaller than an outer diameter of a bottom of the filtration segment facing the sealed portion, or a depth of the first concave cavity is greater than a sum of the height of the filtration segment and a height of the sealing segment;
wherein a maximum inner diameter of the first concave cavity is greater than or equal to a maximum outer diameter of the filtration segment; and/or a diameter of the first concave cavity gradually decreases in a direction from the first cavity opening to the cavity bottom wall.

8. The brewing cup of claim 6, wherein the filtration head is further provided with a second concave cavity, and the second concave cavity is recessed relative to the connecting segment and extends from the connecting segment to the sealing segment and the filtration segment;
the filtration segment comprises a first filtration bottom wall and a first filtration side wall, and the first filtration side wall extends with a gradually increasing diameter or with a constant diameter from a circumferential edge of the first filtration bottom wall to the sealing segment; and
the plurality of filter holes comprise a plurality of first filter holes formed in the first filtration bottom wall and in communication with the second concave cavity and/or a plurality of second filter holes formed in the first filtration side wall and in communication with the second concave cavity.

9. The brewing cup of claim 6, wherein the filtration head is further provided with a second concave cavity and a third concave cavity, the second concave cavity is recessed relative to the connecting segment and extends from the connecting segment to the sealing segment and the filtration segment, and the third concave cavity is recessed at a bottom of the filtration segment;
the filtration segment comprises a second filtration bottom wall, a second filtration side wall, and a third filtration side wall, the second filtration side wall forms an outer circumferential wall of the filtration segment, the second filtration bottom wall and the third filtration side wall define the third concave cavity, the third filtration side wall extends from a bottom end of the second filtration side wall toward the second concave cavity to a circumferential edge of the second filtration bottom wall; and
the plurality of filter holes comprises a plurality of third filter holes formed in the second filtration bottom wall and in communication with the second concave cavity, a plurality of fourth filter holes formed in the second filtration side wall and in communication with the second concave cavity, and a plurality of fifth filter holes formed in the third filtration side wall and in communication with the second concave cavity;
wherein a height of the filtration segment is smaller than or equal to a height of the connecting segment; and/or a height of the filtration segment is smaller than or equal to a height of the sealing segment.

10. The brewing cup of claim 9, wherein a maximum outer diameter of the second filtration side wall is smaller than an outer diameter of an end portion of the sealing segment away from the connecting segment; and/or
the second filtration side wall extends with a gradually increasing diameter or with a constant diameter from a bottom wall of the sealing segment in a direction away from the connecting segment, and the third filtration side wall extends with a gradually increasing diameter or with a constant diameter from the bottom end of the second filtration side wall to the circumferential edge of the second filtration bottom wall.

11. The brewing cup of claim 9, wherein a distribution area of the plurality of filter holes in the filtration segment is greater than or equal to 20% of a surface area of the filtration segment.

12. The brewing cup of claim 1, wherein a flange extending outward is provided at an edge of a top of the paper filter, and the flange is configured to overlap an edge of the first opening before the pushing member pushes the filtration member and the paper filter to move toward the sealed portion; and/or
a maximum outer diameter of the paper filter is greater than an inner diameter of the first opening.

13. The brewing cup of claim 1, wherein the filtration member comprises a cylinder and a filtration head, and the filtration head is configured to be assembled to or integrally formed on an end of the cylinder facing the sealed portion;
the paper filter is separably connected to the filtration head, and is configured to wrap the filtration head when the filtration member pushes the paper filter to move toward the sealed portion;
at least two first pressing portions spaced apart in a circumferential direction of the cylinder are formed protruding from an inner side wall of the cylinder;
at least two second pressing portions spaced apart in a circumferential direction of the pushing member are formed on an outer circumferential side of the pushing member; and
when the second pressing portions are respectively opposite to and press against the first pressing portions, the pushing member is configured to push, under an external force, the cylinder to drive the filtration head and the paper filter to move in the direction from the first opening to the sealed portion;
wherein a number of the first pressing portions is an integer multiple of a number of the second pressing portions, and the integer multiple is greater than or equal to one; and/or between the first pressing portion and an end portion of the cylinder away from the filtration head, a spacing is provided, which is smaller than a distance from the first pressing portion to an end portion of the cylinder adjacent to the filtration head.

14. The brewing cup of claim 13, wherein the pushing member comprises a transverse plate and at least two vertical plates, a bottom surface of the transverse plate is connected to a top end of each of the at least two vertical plates, inner sides of the at least two vertical plates adjacent to a central axis of the transverse plate intersect each other, and outer peripheral sides of the at least two vertical plates away from the central axis of the transverse plate are arranged at intervals in a circumferential direction of the transverse plate; and
each of the at least two vertical plates is provided with the respective second pressing portion protruding from the outer peripheral side thereof away from the central axis of the transverse plate, and each of the second pressing portions is arranged adjacent to a bottom end of the respective vertical plate;
wherein each of the first pressing portions is a first protruding block extending in an arc shape in a circumferential direction of the inner side wall of the cylinder; each of the second pressing portions is a second protruding block extending from an end portion of the respective vertical plate away from the transverse plate and protruding from the outer peripheral side of the respective vertical plate; a circumferential extending length of the second protruding block is greater than a circumferential extending length of the respective first protruding block, and the second protruding block is configured to press against the respective first protruding block, so that the respective second pressing portion presses against the respective first pressing portion; and/or a number of the vertical plates is four, three, or two.

15. The brewing cup of claim 13, wherein the pushing member comprises a rod, and the rod is provided with the second pressing portions protruding from an outer side wall thereof;
wherein each of the first pressing portions is a protrusion protruding from the inner side wall of the cylinder; each of the second pressing portions is a slot, the slot is provided with a slot opening facing the sealed portion and a first slot wall spaced apart from and opposite to the slot opening, and the protrusion is configured to be engaged in the respective slot and press against the first slot wall, so that the respective second pressing portion presses against the respective first pressing portion; and/or the rod is provided with an inner hole along a central axis thereof.

16. The brewing cup of claim 13, wherein the cylinder is further provided with an elongated opening extending from an outer side wall of the cylinder to the inner side wall of the cylinder.

17. The brewing cup of claim 1, wherein the brewing cup further comprises a top lid separably connected to the cup body, and when the top lid is connected to the cup body, the top lid closes and seals the first opening and defines a sealed space with the cup body; and an end portion of the pushing member away from the sealed portion is separably connected to the top lid, or the pushing member is integrally formed with the top lid;
wherein the top lid is provided with a gripping portion for a user to grip and push the pushing member, so as to drive the filtration assembly to move in the direction from the first opening to the sealed portion,
wherein an outer diameter of the gripping portion is greater than or equal to 50% of an inner diameter of the first opening.

18. The brewing cup of claim 17, wherein the outer diameter of the gripping portion is greater than or equal to 80% of the inner diameter of the first opening.

19. The brewing cup of claim 17, wherein the brewing cup further comprises a second sealing ring arranged between the top lid and the cup body to seal a fitting gap between the top lid and the cup body when the top lid is connected to and closes the cup body.

20. The brewing cup of claim 1, wherein the cup body comprises a cylindrical body and a bottom lid, one end of the cylindrical body is provided with the first opening, another end of the cylindrical body is provided with a second opening, the bottom lid is separably connected to the end of the cylindrical body provided with the second opening, and when the bottom lid is mounted to the cylindrical body, the bottom lid closes and seals the second opening to form the sealed portion.
